(19) United States
(12) Patent Application Publication
(10) Pub. No.: US 2026/0269920 A1
(43) Pub. Date: Sep. 10, 2026

(54) CROSS FREQUENCY RANGE INFORMATION FOR BEAM PREDICTION

(71) Applicant: QUALCOMM Incorporated, San Diego, CA (US)

(72) Inventors: Qiaoyu LI, Beijing (CN); Tao LUO, San Diego, CA (US); Mahmoud TAHERZADEH BOROUJENI, San Diego, CA (US)

(21) Appl. No.: 19/168,114

(22) PCT Filed: May 16, 2023
(86) PCT No.: PCT/CN2023/094414

§ 371 Date: Sep. 23, 2025

(51) Int. Cl. H04B 7/06; H04B 7/08; H04W 36/06

(52) U.S. Cl. CPC H04B 7/06952; H04B 7/088; H04W 36/06

(57) ABSTRACT

Methods, systems, and devices for wireless communications are described. A user equipment (UE) may transmit a set of sounding reference signals (SRSs) using a set of beams of the UE via a first serving cell that may support communications for the UE using a first frequency range. The UE may then receive directional information for the UE based on channel propagation characteristics between the UE and a network entity, where the channel propagation characteristics may be based on the SRSs transmitted via the first serving cell. Based on the directional information, the UE may perform a beam prediction procedure to predict an uplink beam of the UE for communicating via a second serving cell that may be different from the first serving cell. The UE may then transmit one or more uplink messages, using the uplink beam of the UE, via the second serving cell using a second frequency range.

### CROSS REFERENCE

The present Application is a 371 national phase filing of International PCT Application No. PCT/CN2023/094414 by LI et al., entitled “CROSS FREQUENCY RANGE INFORMATION FOR BEAM PREDICTION,” filed May 16, 2023, which is assigned to the assignee hereof, and which is expressly incorporated by reference in its entirety herein.

### FIELD OF TECHNOLOGY

The following relates to wireless communications, including cross frequency range information for beam prediction.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, devices (e.g., UEs) may have a line-of sight (LoS) or a non-LoS (NLoS) with a network entity. LoS may refer to a set of beams of a UE being directed to the network entity and supporting communications with the network entity. NLoS may refer to when the beams of the UE may be blocked by obstacles or clusters, preventing the beams from being able to effectively communicate with the network entity

### SUMMARY

The described techniques relate to improved methods, systems, devices, and apparatuses that support cross frequency range information for beam prediction. For example, the described techniques provide for a user equipment (UE) transmitting a set of sounding reference signals (SRSs) using a set of beams of the UE via a first serving cell that may support communications for the UE using a first frequency range. The UE may then receive a control signal including directional information for the UE based on channel propagation characteristics between the UE and a network entity, where the channel propagation characteristics may be based on the SRSs transmitted via the first serving cell. Based on the directional information, the UE may perform a beam prediction procedure to predict an uplink beam of the UE for communicating via a second serving cell that may be different from the first serving cell. The UE may then transmit one or more uplink messages, using the uplink beam of the UE, via the second serving cell using a frequency range different from the first frequency range based on the beam prediction procedure.

A method for wireless communications at UE is described. The method may include transmitting, using a set of multiple beams of the UE, a set of multiple SRSs via a first serving cell that supports communications for the UE using a first frequency range, receiving a control signal including directional information for the UE the directional information based on channel propagation characteristics between the UE and a network entity, where the channel propagation characteristics are based on the set of multiple SRSs transmitted via the first serving cell, performing, based on the directional information, a beam prediction procedure to predict an uplink beam of the UE for communicating via a second serving cell different from the first serving cell, and transmitting, using the uplink beam of the UE, one or more uplink messages via the second serving cell using a second frequency range different from the first frequency range based on the beam prediction procedure.

An apparatus for wireless communications at UE is described. The apparatus may include a processor, memory coupled with the processor, and instructions stored in the memory. The instructions may be executable by the processor to cause the apparatus to transmit, using a set of multiple beams of the UE, a set of multiple SRSs via a first serving cell that supports communications for the UE using a first frequency range, receive a control signal including directional information for the UE the directional information based on channel propagation characteristics between the UE and a network entity, where the channel propagation characteristics are based on the set of multiple SRSs transmitted via the first serving cell, perform, based on the directional information, a beam prediction procedure to predict an uplink beam of the UE for communicating via a second serving cell different from the first serving cell, and transmit, using the uplink beam of the UE, one or more uplink messages via the second serving cell using a second frequency range different from the first frequency range based on the beam prediction procedure.

Another apparatus for wireless communications at UE is described. The apparatus may include means for transmitting, using a set of multiple beams of the UE, a set of multiple SRSs via a first serving cell that supports communications for the UE using a first frequency range, means for receiving a control signal including directional information for the UE the directional information based on channel propagation characteristics between the UE and a network entity, where the channel propagation characteristics are based on the set of multiple SRSs transmitted via the first serving cell, means for performing, based on the directional information, a beam prediction procedure to predict an uplink beam of the UE for communicating via a second serving cell different from the first serving cell, and means for transmitting, using the uplink beam of the UE, one or more uplink messages via the second serving cell using a second frequency range different from the first frequency range based on the beam prediction procedure.

A non-transitory computer-readable medium storing code for wireless communications at UE is described. The code may include instructions executable by a processor to transmit, using a set of multiple beams of the UE, a set of multiple SRSs via a first serving cell that supports communications for the UE using a first frequency range, receive a control signal including directional information for the UE the directional information based on channel propagation characteristics between the UE and a network entity, where the channel propagation characteristics are based on the set of multiple SRSs transmitted via the first serving cell, perform, based on the directional information, a beam prediction procedure to predict an uplink beam of the UE for communicating via a second serving cell different from the first serving cell, and transmit, using the uplink beam of the UE, one or more uplink messages via the second serving cell using a second frequency range different from the first frequency range based on the beam prediction procedure.

In some examples of the method, apparatuses, and non-transitory computer-readable medium described herein, transmitting the one or more uplink messages may include operations, features, means, or instructions for transmitting, using the uplink beam of the UE, the one or more uplink messages via the second serving cell using the second frequency range, where the second frequency range may be higher in frequency than the first frequency range.

Some examples of the method, apparatuses, and non-transitory computer-readable medium described herein may further include operations, features, means, or instructions for transmitting the set of multiple SRSs via the first serving cell via a first set of frequency resources of the first frequency range and transmitting the one or more uplink messages via the second serving cell using a second set of frequency resources of the second frequency range.

In some examples of the method, apparatuses, and non-transitory computer-readable medium described herein, receiving the control signal may include operations, features, means, or instructions for receiving, via the first serving cell using the first frequency range or via the second serving cell using the second frequency range, a DCI message or a medium access control control element (MAC-CE) message that includes the directional information for the UE.

In some examples of the method, apparatuses, and non-transitory computer-readable medium described herein, receiving the DCI message via the first serving cell may include operations, features, means, or instructions for receiving the DCI message including an uplink grant that schedules transmission of an uplink message via the second serving cell, where the one or more uplink messages includes the uplink message.

In some examples of the method, apparatuses, and non-transitory computer-readable medium described herein, receiving the DCI message via the second serving cell may include operations, features, means, or instructions for receiving the DCI message including a downlink grant indicating a transmission configuration indication (TCI) state change, the TCI state change indicating the directional information.

In some examples of the method, apparatuses, and non-transitory computer-readable medium described herein, receiving the DCI message via the second serving cell may include operations, features, means, or instructions for receiving, via the second serving cell, the DCI message including an uplink grant scheduling a transmission of an uplink message via the second serving cell, the one or more uplink messages including the uplink message, the DCI message including a SRS resource indicator (SRI) indicating the directional information or a transmit precoder matrix indicator (TPMI) indicating the directional information.

Some examples of the method, apparatuses, and non-transitory computer-readable medium described herein may further include operations, features, means, or instructions for receiving, before reception of the control signal, a radio resource control (RRC) message indicating that the directional information may be based on the set of multiple SRSs transmitted via the first serving cell.

In some examples of the method, apparatuses, and non-transitory computer-readable medium described herein, receiving the MAC-CE message via the first serving cell or via the second serving cell may include operations, features, means, or instructions for receiving the MAC-CE message including the directional information, where the MAC-CE message indicates a serving cell ID associated with the first serving cell.

In some examples of the method, apparatuses, and non-transitory computer-readable medium described herein, receiving the control signal may include operations, features, means, or instructions for receiving the control signal including the directional information based on estimated uplink angle of arrival (AoA) information, the estimated uplink AoA information based on the set of multiple SRSs transmitted via the first serving cell.

In some examples of the method, apparatuses, and non-transitory computer-readable medium described herein, receiving the control signal may include operations, features, means, or instructions for receiving the control signal including the directional information that indicates one or more SRS resources used for transmission of the set of multiple SRSs or one or more SRS ports used for transmission of the set of multiple SRSs.

In some examples of the method, apparatuses, and non-transitory computer-readable medium described herein, receiving the control signal may include operations, features, means, or instructions for receiving, via the second serving cell, the control signal including an uplink TCI state configuration, the uplink TCI state configuration including the directional information that may be based on the set of multiple SRSs transmitted via the first serving cell.

Some examples of the method, apparatuses, and non-transitory computer-readable medium described herein may further include operations, features, means, or instructions for transmitting, using the set of multiple beams of the UE, the set of multiple SRSs via the first serving cell and via a third serving cell that supports communications for the UE using a third frequency range different from both the first frequency range and the second frequency range.

A method for wireless communications at a first network entity is described. The method may include receiving, from a UE, a set of multiple SRSs via a first serving cell that supports communications with the UE using a first frequency range and transmitting a control signal including directional information to the UE via the first serving cell, the directional information based on channel propagation characteristics between the UE and the first network entity where the channel propagation characteristics are based on the set of multiple SRSs received via the first serving cell.

An apparatus for wireless communications at a first network entity is described. The apparatus may include a processor, memory coupled with the processor, and instructions stored in the memory. The instructions may be executable by the processor to cause the apparatus to receive, from a UE, a set of multiple SRSs via a first serving cell that supports communications with the UE using a first frequency range and transmit a control signal including directional information to the UE via the first serving cell, the directional information based on channel propagation characteristics between the UE and the first network entity where the channel propagation characteristics are based on the set of multiple SRSs received via the first serving cell.

Another apparatus for wireless communications at a first network entity is described. The apparatus may include means for receiving, from a UE, a set of multiple SRSs via a first serving cell that supports communications with the UE using a first frequency range and means for transmitting a control signal including directional information to the UE via the first serving cell, the directional information based on channel propagation characteristics between the UE and the first network entity where the channel propagation characteristics are based on the set of multiple SRSs received via the first serving cell.

A non-transitory computer-readable medium storing code for wireless communications at a first network entity is described. The code may include instructions executable by a processor to receive, from a UE, a set of multiple SRSs via a first serving cell that supports communications with the UE using a first frequency range and transmit a control signal including directional information to the UE via the first serving cell, the directional information based on channel propagation characteristics between the UE and the first network entity where the channel propagation characteristics are based on the set of multiple SRSs received via the first serving cell.

Some examples of the method, apparatuses, and non-transitory computer-readable medium described herein may further include operations, features, means, or instructions for receiving the set of multiple SRSs via the first serving cell via a set of frequency resources of the first frequency range.

In some examples of the method, apparatuses, and non-transitory computer-readable medium described herein, transmitting the control signal may include operations, features, means, or instructions for transmitting, via the first serving cell using the first frequency range, a DCI message or a MAC-CE message that includes the directional information for the UE.

In some examples of the method, apparatuses, and non-transitory computer-readable medium described herein, transmitting the DCI message via the first serving cell may include operations, features, means, or instructions for transmitting the DCI message including an uplink grant that schedules transmission of an uplink message via a second serving cell using a second frequency range.

In some examples of the method, apparatuses, and non-transitory computer-readable medium described herein, transmitting the control signal may include operations, features, means, or instructions for transmitting the control signal including the directional information that indicates one or more SRS resources used for receiving of the set of multiple SRSs or one or more SRS ports used for reception of the set of multiple SRSs.

Some examples of the method, apparatuses, and non-transitory computer-readable medium described herein may further include operations, features, means, or instructions for receiving, the set of multiple SRSs via the first serving cell and via a third serving cell that supports communication for the UE using a third frequency range different from the first frequency range.

A method for wireless communications at a first network entity is described. The method may include receiving, from a second network entity, a message indicating channel propagation characteristics between a UE and the second network entity, the second network entity operating via a first serving cell using a first frequency range, transmitting a control signal including directional information to the UE via a second serving cell using a second frequency range different from the first frequency range, the directional information identified based on the message from the second network entity including the channel propagation characteristics between the UE and the second network entity via the first serving cell, and receiving, one or more uplink messages, from an uplink beam of the UE, the one or more uplink messages received via the second serving cell using the second frequency range in accordance with the directional information.

An apparatus for wireless communications at a first network entity is described. The apparatus may include a processor, memory coupled with the processor, and instructions stored in the memory. The instructions may be executable by the processor to cause the apparatus to receive, from a second network entity, a message indicating channel propagation characteristics between a UE and the second network entity, the second network entity operating via a first serving cell using a first frequency range, transmit a control signal including directional information to the UE via a second serving cell using a second frequency range different from the first frequency range, the directional information identified based on the message from the second network entity including the channel propagation characteristics between the UE and the second network entity via the first serving cell, and receive, one or more uplink messages, from an uplink beam of the UE, the one or more uplink messages received via the second serving cell using the second frequency range in accordance with the directional information.

Another apparatus for wireless communications at a first network entity is described. The apparatus may include means for receiving, from a second network entity, a message indicating channel propagation characteristics between a UE and the second network entity, the second network entity operating via a first serving cell using a first frequency range, means for transmitting a control signal including directional information to the UE via a second serving cell using a second frequency range different from the first frequency range, the directional information identified based on the message from the second network entity including the channel propagation characteristics between the UE and the second network entity via the first serving cell, and means for receiving, one or more uplink messages, from an uplink beam of the UE, the one or more uplink messages received via the second serving cell using the second frequency range in accordance with the directional information.

A non-transitory computer-readable medium storing code for wireless communications at a first network entity is described. The code may include instructions executable by a processor to receive, from a second network entity, a message indicating channel propagation characteristics between a UE and the second network entity, the second network entity operating via a first serving cell using a first frequency range, transmit a control signal including directional information to the UE via a second serving cell using a second frequency range different from the first frequency range, the directional information identified based on the message from the second network entity including the channel propagation characteristics between the UE and the second network entity via the first serving cell, and receive, one or more uplink messages, from an uplink beam of the UE, the one or more uplink messages received via the second serving cell using the second frequency range in accordance with the directional information.

In some examples of the method, apparatuses, and non-transitory computer-readable medium described herein, receiving the one or more uplink messages may include operations, features, means, or instructions for receiving, from the uplink beam of the UE, the one or more uplink messages via the second serving cell using the second frequency range, where the second frequency range may be higher in frequency than the first frequency range.

Some examples of the method, apparatuses, and non-transitory computer-readable medium described herein may further include operations, features, means, or instructions for receiving the one or more uplink messages via the second serving cell using a set of frequency resources of the second frequency range.

In some examples of the method, apparatuses, and non-transitory computer-readable medium described herein, transmitting the control signal may include operations, features, means, or instructions for transmitting, via the second serving cell using the second frequency range, a DCI message or a MAC-CE that includes the directional information for the UE.

In some examples of the method, apparatuses, and non-transitory computer-readable medium described herein, transmitting the DCI message via the second serving cell may include operations, features, means, or instructions for transmitting the DCI message including a downlink grant indicating a TCI state change indicating the directional information.

In some examples of the method, apparatuses, and non-transitory computer-readable medium described herein, transmitting the DCI message via the second serving cell may include operations, features, means, or instructions for transmitting, via the second serving cell, the DCI message including an uplink grant scheduling a transmission of an uplink message via the second serving cell, the one or more uplink messages including the uplink message, the DCI message including an SRI indicating the directional information or a TPMI indicating the directional information.

In some examples of the method, apparatuses, and non-transitory computer-readable medium described herein, transmitting the control signal may include operations, features, means, or instructions for transmitting, via the second serving cell, the control signal including an uplink TCI state configuration, the uplink TCI state configuration including the directional information.

### BRIEF DESCRIPTION OF THE DRAWINGS

FIG. 1 shows an example of a wireless communications system that supports cross frequency range information for beam prediction in accordance with one or more aspects of the present disclosure.

FIG. 2 shows an example of a wireless communications system that supports cross frequency range information for beam prediction in accordance with one or more aspects of the present disclosure.

FIG. 3 shows an example of a flow chart that supports cross frequency range information for beam prediction in accordance with one or more aspects of the present disclosure.

FIG. 4 shows an example of a machine learning diagram that supports cross frequency range information for beam prediction in accordance with one or more aspects of the present disclosure.

FIG. 5 shows an example of a process flow that supports cross frequency range information for beam prediction in accordance with one or more aspects of the present disclosure.

FIGS. 6 and 7 show block diagrams of devices that support cross frequency range information for beam prediction in accordance with one or more aspects of the present disclosure.

FIG. 8 shows a block diagram of a communications manager that supports cross frequency range information for beam prediction in accordance with one or more aspects of the present disclosure.

FIG. 9 shows a diagram of a system including a device that supports cross frequency range information for beam prediction in accordance with one or more aspects of the present disclosure.

FIGS. 10 and 11 show block diagrams of devices that support cross frequency range information for beam prediction in accordance with one or more aspects of the present disclosure.

FIG. 12 shows a block diagram of a communications manager that supports cross frequency range information for beam prediction in accordance with one or more aspects of the present disclosure.

FIG. 13 shows a diagram of a system including a device that supports cross frequency range information for beam prediction in accordance with one or more aspects of the present disclosure.

FIGS. 14 through 18 show flowcharts illustrating methods that support cross frequency range information for beam prediction in accordance with one or more aspects of the present disclosure.

### DETAILED DESCRIPTION

In some wireless communication systems, UEs may communicate with a network entity using transmit beams, and to determine which transmit beam(s) to use for communications with the network entity, the UE may perform a beam sweeping procedure. During the beam sweeping procedure, the UE may transmit reference signals using each of the different transmit beams supported by the UE, and by measuring these reference signals, the network entity may select a transmit beam for the UE. If the UE supports multiple frequency bands (e.g., frequency range 1 (FR1), frequency range 2 (FR2), frequency range 3 (FR3), frequency range 4 (FR4)), or if the UE supports communications via multiple cells, performing beam sweeping for each of the supported frequency bands and for each of the multiple cells may increase the overhead and latency in the wireless communication system. As such, beam sweeping techniques may be result in relatively high levels of time-consumption and resource-consumption. Further, as UE capabilities for supporting these multiple frequency bands or multiple cells may increase as wireless technology evolves, this issue may increase and have a greater negative impact on wireless communications.

As such, a network entity may indicate line of sight (LoS) or non-LoS (NLoS) information to the UE, which the UE may use to predict an uplink beam to use for communicating using a different frequency range, via a different cell, or both. The LoS information may indicate which beams have the most efficient line of sight and therefore may be used for communicating in a different frequency range or a different cell co-located with the network entity. The NLoS information may indicate beams that have the least efficient line of sight and therefore should be avoided for communicating in a different frequency range or a different cell co-located with the network entity. To obtain the LoS or NLoS information, the UE may transmit reference signals (e.g., sounding reference signals (SRSs)) to a serving cell and a network entity may generate the LoS or NLoS information and transmit the LoS or NLoS information the UE. The UE may use the LoS or NLoS information as part of a beam prediction procedure to predict an uplink beam for subsequent communications. Such LoS or NLoS information may allow the UE to accurately predict an uplink beam without having to perform beam sweeping across all beams, cells, and frequency ranges, which may decrease the latency, time, and resource consumption at the UE.

Aspects of the disclosure are initially described in the context of wireless communications systems. Additional aspects of the disclosure are described herein with reference to a wireless communications system, a flowchart, a machine learning diagram, and a process flow. Aspects of the disclosure are further illustrated by and described with reference to apparatus diagrams, system diagrams, and flowcharts that relate to cross frequency range information for beam prediction.

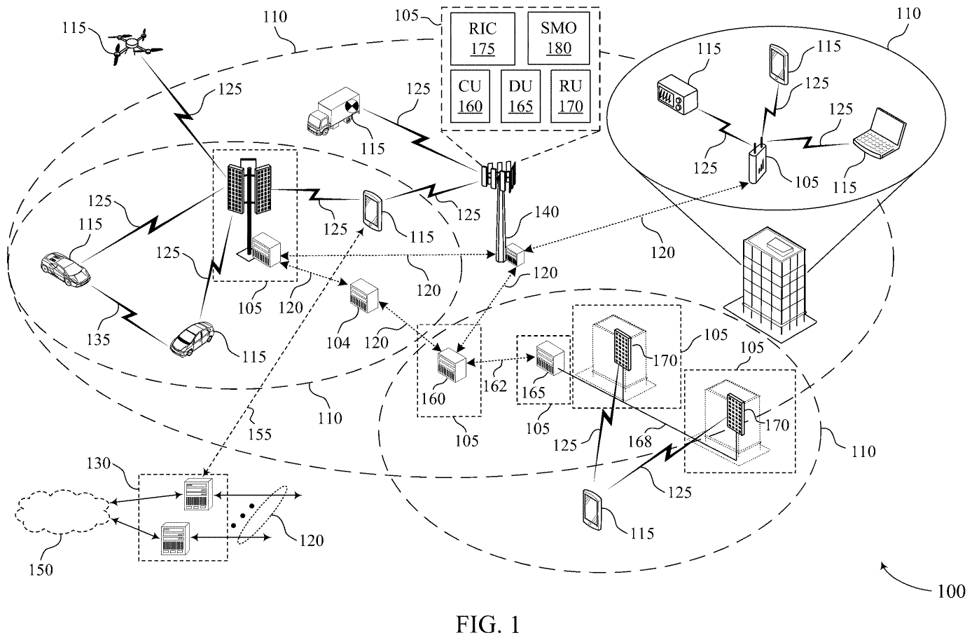

FIG. 1 shows an example of a wireless communications system 100 that supports cross frequency range information for beam prediction in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUS 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (VIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support cross frequency range information for beam prediction as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the EHF band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR 1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples of the wireless communications system 100, the UE 115 and the network entity 105 may use artificial intelligence (AI) or machine learning procedures and models to enhance beam management. For example, such AI and machine learning models may be used for beam predictions in the time domain, beam predictions in the spatial domain, or both, to reduce overhead and latency and increase beam selection accuracies. In some cases, the AI and machine learning techniques may support collaborations between wireless devices, such as the network entity 105 and the UE 115. As such, the network entity 105 and the UE 115 may perform model training, model deployment, model inference, model monitoring, and model updating for the various AI and machine learning models used for beam prediction to identify common characteristics or specific characteristics for the beam predictions.

In some examples, wireless devices that support AI and machine learning based beam management (e.g., the UE 115 and the network entity 105) may support a first beam management case and a second beam management case for characterization and baseline performance evaluations. The first beam management case may include the wireless devices performing spatial-domain downlink beam predictions for a first set of beams based on measurement results of a second set of beams. In some cases, the second set of beams may be a subset of the first set of beams, where the wireless device may select or generate the second set of beams via a fixed pattern, a random pattern, or any other type of technique. In some cases, the first set of beams and the second set of beams may be different (e.g., the first set of beams include narrow beams and the second set of beams include wide beams). In some examples, the first set of beams and the second set of beams may have a same quantity of beams, have different quantities of beams, be quasi co-located (QCL) with each other, or any combination thereof.

The second beam management case may include the wireless devices performing temporal downlink beam predictions for the first set of beams based on historic measurement results of the second set of beams. That is, the AI and machine learning models may be used to discover patterns in the historical measurement results of the second set of beams to generate the temporal downlink beam predictions for the first set of beams. In either the first beam management case or the second beam management case, the first set of beams and the second set of beams may be in the same frequency or in different frequencies. Additionally, or alternatively, the codebook constructions for the first set of beams and the second set of beams may be configured by the manufacturers of the wireless devices.

For the first beam management case when the UE 115 uses the AI and machine learning models, layer (L1) signaling may be used to report information associated with the AI and machine learning model interference to the network entity 105. The UE 115 may report information such as beams based on the output of the AI and machine learning model inference, predicted L1-reference signal receive power (RSRP) corresponding to the output beams, or other types of information. For the second beam management case when the UE 115 uses the AI and machine learning models, L1-signaling may be used to report information to the network entity 105, such as beams of N future time instances based on the output of the AI or machine learning model inference, the value of N, the predicted L1-RSRPs corresponding to the beams, information (e.g., explicit information or implicit information) about the timestamps corresponding to the reported beams, or any combination thereof.

For both the first beam management case and the second beam management case, when the UE 115 performs model monitoring, the UE 115 may monitor the performance metrics of the AI and machine learning models, make decisions about model selection, activation, deactivation, switching, fallback operations, or any combination thereof. When the network entity 105 performs the model monitoring, the network entity 105 may model the performance metrics of the AI and machine learning models and make decisions for the AI and machine learning models in a similar fashion as the UE 115. In some cases, both devices (e.g., the UE 115 and the network entity 105) may perform model monitoring and the UE 115 may monitor the performance metrics of the AI and machine learning models and the network entity 105 may make decisions about model selection, activation, deactivation, switching, fallback operations, or any combination thereof. In some cases, when the network entity 105 monitors the AI and machine learning models, the network entity 105 may perform beam measurements and generate reports based on the model monitoring.

In some examples of the wireless communications system 100, UEs 115 may communicate with a network entity 105 using transmit beams. To determine which transmit beam(s) to use for communications with the network entity 105, the UE 115 may perform a beam sweeping procedure. During the beam sweeping procedure, the UE 115 may transmit reference signals using each of the different transmit beams supported by the UE 115, and by measuring these reference signals, the network entity 105 may select a transmit beam for the UE 115. If the UE 115 supports multiple frequency bands (e.g., FR1, FR2, FR3, FR4), and or if the UE 115 supports communications via multiple cells, performing beam sweeping for each of the supported frequency bands and for each of the multiple cells may increase the overhead and latency in the wireless communications system 100. As such, beam sweeping techniques may be result in relatively high levels of time-consumption and resource-consumption. Further, as UE 115 capabilities for supporting these multiple frequency bands or multiple cells may increase as wireless technology may advance, this will continue to be an issue.

As such, a network entity 105 may indicate LoS or NLoS information to the UE 115 so the UE 115 may predict an uplink beam to use for communicating using a different frequency range, via a different cell, or both. The LoS information may indicate which beams have the most efficient line of sight and therefore may be used for communicating in a different frequency range or a different cell co-located with the network entity 105. The NLoS information may indicate beams that have the least efficient line of sight and therefore may be avoided for communicating in a different frequency range or a different cell co-located with the network entity 105. To obtain the LoS or NLoS information, the UE 115 may transmit reference signals (e.g., SRSs) to a serving cell and a network entity 105 may generate the LoS or NLoS information and transmit the LoS or NLoS information the UE 115. The UE 115 may use the LoS or NLoS information as part of a beam prediction procedure to predict an uplink beam for subsequent communications. Such the LoS or NLoS information may allow the UE 115 to accurately predict an uplink beam without having to perform beam sweeping across all beams, cells, and frequency ranges, which may decrease the latency, time, and resource consumption at the UE 115.

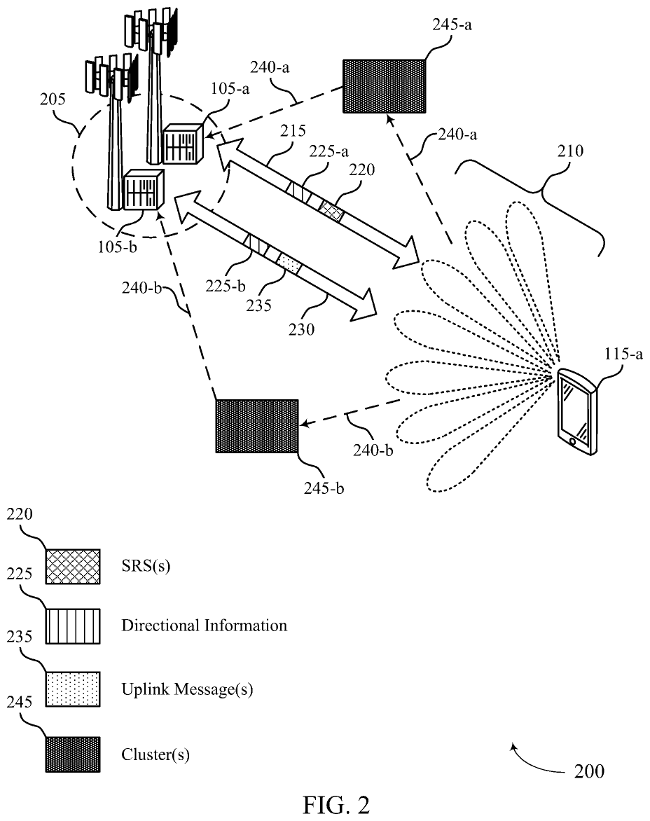

FIG. 2 shows an example of a wireless communications system 200 that supports cross frequency range information for beam prediction in accordance with one or more aspects of the present disclosure. In some examples, the wireless communications system 200 may implement or be implemented by the wireless communications system 100. For example, the wireless communications system 200 may include a UE 115-a, a network entity 105-a, and a network entity 105-b which may be examples of corresponding devices described herein with reference to FIG. 1. In some examples, the network entity 105-a and the network entity 105-b may be co-located at 205 (e.g., the receive antennas of the network entity 105-a and the network entity 105-b may be co-located). The UE 115-a may use a set of beams 210 of the UE 115-a to communicate with the network entity 105-a via a communication link 215 and communicate with the network entity 105-b via a communication link 230. The communication link 215 and the communication link 230 may be examples of a Uu link, a sidelink, a backhaul link, a D2D link or some other type of communication link 125.

In some examples, the network entity 105-a or the network entity 105-b may predict L1-RSRPs for downlink beams and the UE 115-a may predict the associated receiving beam. The UE 115-a may use the predicted beam for subsequent uplink transmissions based on whether the UE 115-a has beam correspondence with the network entity 105-a or the network entity 105-b. In some cases, the beam used for uplink transmissions may use the same spatial filters as the predicted receiving beam, and therefore the UE 115-a may use the beam for subsequent uplink transmissions with the network entity 105-a or with the network entity 105-b.

In some other examples, the prediction of uplink transmit beams may be based on uplink reference signals. In such examples, there may be various benefits in the time domain, spatial domain, and the frequency domain, from using uplink reference signals to predict an uplink transmit beam. For example, in the time domain, when subsequent or future uplink beams (e.g., physical uplink shared channel (PUSCH) transmit beams), the UE 115-a may transmit SRSs 220 less frequently which may reduce signaling overhead and power consumption at the UE. As such, the network entity 105-a may have a more flexible prediction of SRSs and uplink transmission configuration indication (TCI) states or SRS resource indicator predictions. Further, predictions at both the network entity 105-a and the UE 115-a may improve for network entity 105-a guided future uplink-TCI state, SRS resource indicator (SRI), or uplink angle of arrival (AoA) predictions.

In the spatial domain and the time domain, as the SRS 220 transmissions may be spatially sparse which may also lead to reduced signaling overhead and power consumption. Additionally, or alternatively, as a relatively better uplink transmit beam may be predicted, the accuracy and reliability of the UE 115-a may increase. Therefore, the network entity 105-a may be better able to predict indications of linear combinations of SRS resources as an SRI, indications of uplink-AoAs as uplink TCI-states, or both. In the frequency domain, in some examples, uplink transmit beams for higher frequency bands (e.g., FR2/FR4) may be predicted via lower frequency bands (e.g., FR1/FR3) which may lead to better coverage and relatively less radio frequency phase shifting which may lead to reduced power consumption at the UE 115-a. In some cases, the lower frequency bands may be referred to as a first frequency range and the higher frequency bands may be referred to as a second frequency range. Further, the UE 115-a may use a lower quantity of beams in the first frequency range which may lead to reduced signaling overhead when transmitting SRSs 220. For example, using SRS ports in the first frequency range may emulate cross-polarization in a higher frequency range. Further, digital beamforming in the first frequency range may also emulate uplink beams in the second frequency range. Additionally, or alternatively, lower frequency NLoS information indications may be used for beam avoidance in higher frequencies when predicting uplink beams at the UE 115-a. In some cases, indicating lower frequency uplink TCI-state, SRI, uplink-AoA, or any combination thereof may also assist beam predictions at the UE 115-a when scheduling higher frequency uplink messages (e.g., PUSCH).

As such, performing uplink beam sweeping using the second frequency range (e.g., FR2/FR4) may result in an increase in power consumption and signaling overhead for the UE 115-a. Further, LoS or NLoS information may be relatively difficult to directly estimate and obtain in the second frequency range due to the directional propagation characteristics of the second frequency range. Therefore, when performing beam sweeping for the second frequency range, the UE 115-a may have to perform brute-forced based beam sweeping or random beam sweeping to identify an appropriate uplink transmit beam of the set of beams 210 at the UE 115-a. That is, the UE 115-a may test each beam of the set of beams 210 or randomly test beams of the set of beams 210 until the UE 115-a obtains an appropriate uplink transmit beam, which may be relatively time and power consuming. In some cases, the beam sweeping may be especially inefficient in cases where beam correspondence between the network entities 105 (e.g., the network entity 105-a and the network entity 105-b) and the UE 115-a may be unavailable.

In some examples, LoS or NLoS information estimated by the network entity 105-a based on the SRSs 220 transmitted using the first frequency range (e.g., FR1/FR3) may aid the UE 115-a in determining uplink transmit beams for communicating using the second frequency range (e.g., FR2/FR4). The LoS or NLoS information may also reduce the signaling overhead and power consumption of the UE 115-a performing uplink transmit beam sweeping in the second frequency range. Since, the LoS or NLoS information may be estimated from SRSs 220 transmitted using the first frequency range (e.g., lower frequencies may support more efficient digital beam forming), the network entities 105 (e.g., the network entity 105-a or the network entity 105-b) may transmit a control message (e.g., a downlink control information (DCI) message, RRC message, or MAC control element (MAC-CE) message) indicating directional information 225 including the LoS or NLoS information.

In some examples, the directional information 225 may aid the UE 115-a in determining uplink transmission beams from the set of beams 210 for communicating in the second frequency range (e.g., FR2/FR4) or aid in reducing the signaling overhead, power consumption, or both when performing beam sweeping procedures. For example, the UE 115-a may determine an uplink transmit beam for communications (e.g., PUSCH or physical uplink control channel (PUCCH) messages) in the second frequency range based on the directional information 225 by attempting to align the higher frequency uplink transmit beam spatial filters with the indicated LoS directions or avoiding the NLoS directions. The UE 115-a may align the uplink transmit beam via uplink-AoA, SRS resource, or SRS ports associated with the SRS 220 transmitted using the first frequency range. In some other cases, using the direction information the UE 115-a may reduce the efforts of the uplink transmit beam sweeping by avoiding the SRS resources or beams indicated in the NLoS direction information.

Therefore, the signaling enhancement of the network entity 105-a or the network entity 105-b transmitting the control message indicating the directional information 225 to the UE 115-a may aid in cross-frequency uplink beam predictions. For example, the network entity 105-a or the network entity 105-b may control the uplink beams for the second frequency range by indicating the directional information 225 derived from the SRSs 220 transmitted by the UE 115-a using the first frequency range. In some examples, the indication of the directional information 225-a may be via a first serving cell using a first frequency range or the indication of the directional information 225-b may be via a second serving cell using a second frequency range. In some cases, the network entity 105-a may be within the first serving cell and may operate using the first frequency range and the network entity 105-b may be within the second serving cell and may operate using the second frequency range. In cases when the network entity 105-a transmits the directional information 225-a via the first serving cell using the first frequency range, the indication may be referred to as an uplink transmit beak determination for the second frequency range. In some other cases, a TCI-uplink-state may be enhanced to include the directional information as a reference source.

As such, as illustrated in FIG. 2, the UE 115-a may transmit SRSs 220 via the communication link 215 to the network entity 105-a of the first serving cell using the first frequency range using the set of beams 210. In some cases, the UE 115-a may receive the control message indicating the directional information 225-a from the network entity 105-a of the first serving cell using the first frequency range via the communication link 215. In some other cases, the UE 115-a may receive the control message indicating the directional information 225-b from the network entity 105-b of the second serving cell using the second frequency range via the communication link 230. The directional information 225 may be based on the LoS or NLoS information and channel propagation behaviors between the UE 115-a and the network entity 105-a. Further, the network entity 105-a or the network entity 105-b may derive the directional information 225 from the SRS 220 transmitted by the UE 115-a via the first serving cell.

When the UE 115-a receives the directional information 225-a via the first serving cell or receives the directional information 225-b via the second serving cell, the UE 115-a may assume that the receiving antennas of the network entity 105-a and the network entity 105-b may be co-located at 205. That is, the receiving antennas may be shared between the network entity 105-a of the first serving cell and the network entity 105-b of the second serving cell. Further, the network entity 105-b of the second serving cell may expect to receive one or more uplink messages 235 (e.g., SRSs, PUCCH messages, or PUSCH messages from the UE 115-a in accordance with the directional information 225. That is, the UE 15-a may align the uplink transmit spatial filters of the beams of the set of beams 210 of the UE 115-a used to transmit the one or more uplink messages 235 in accordance with the directional information 225 including the LoS or NLoS information derived from the first serving cell.

In some examples, the NLoS information may indicate to avoid channel propagation directions 240 (e.g., a channel propagation direction 240-a and a channel propagation direction 240-b) due to interference with clusters 245 (e.g., a cluster 245-a or a cluster 245-b). For example, the directional information 225 may indicate for the UE 115-a to avoid the channel propagation direction 240-a due to the interference of the cluster 245-a. The cluster 245-a may be an example of a building, a person, or some of other type of obstacle interfering with the UE 115-a transmitting the one or more uplink messages 235. As such, the UE 115-a may refrain from using beams of the set of beams 210 in the direction of the NLoS information (e.g., in the channel propagation directions 240).

Further, the network entity 105-a or the network entity 105-b may transmit the control message indicating the directional information 225 based on estimated uplink-AoA information or directions derived from the SRSs 220 transmitted by the UE 115-a via the first serving cell. For example, a MAC-CE message may indicate detailed LoS or NLoS uplink-AoA directions derived from the SRSs 220 transmitted by the UE 115-a via the first serving cell. In some examples, the network entity 105-a may transmit the directional information 225-a via the first serving cell or the network entity 105-b may transmit the directional information 225-b via the second serving cell via an RRC or MAC-CE message. In some examples, the directional information 225-a and the directional information 225-b may be the same or they may be slightly different based on the network entity 105 used to generate the directional information 225. However, both the directional information 225-a transmitted by the network entity 105-a and the directional information 225-b transmitted by the network entity 105-b may be based on or derived from the SRSs 220 transmitted by the UE 115-a to the network entity 105-a. In some cases, the network entity 105-a or the network entity 105-b may preconfigure a quantity of uplink-AoA directions for the LoS or NLoS information. Further, the UE 115-a may receive a DCI message containing the directional information 225 via the first serving cell or via the second serving cell and the DCI message may further down-select a quantity of the preconfigured uplink-AoA directions to be used for transmitting the one or more uplink messages 235.

In some other examples, the directional information 225 including the LoS or NLoS information may be based on SRS resources or SRS ports used by the UE 115-a to transmit the SRSs 220 via the first serving cell. For example, the network entity 105-b may indicate an SRI regarding the SRSs 220 transmitted via the first serving cell, the SRI being indicated by the network entity 105-b via an uplink-grant DCI via the second serving cell that indicates the directional information 225-b. In some cases, when non-codebook (NCB) based SRS resources for the SRSs 220 may be scheduled in the first serving cell, the uplink-grant DCI may include a first SRI based on SRS resources indicating the strongest LoS SRS resources from a set of SRS resources used to transmit the SRSs 220. In some other cases, the uplink-grant DCI may include a second SRI based on SRS resources indicating the strongest NLoS SRS resources. Additionally, or alternatively, the SRI may be further enhanced to be able to indicate a combination of SRS ports as different SRS-ports may have different LoS or NLoS propagations. Further, a MAC-CE message may indicate the SRI and the MAC-CE message may indicate specific SRS resources or SRS ports for the LoS or NLoS information included in the directional information 225.

Additionally, or alternatively, as described, a TCI-uplink-state configuration may be enhanced to include the directional information 225 derived from the first serving cell and may be received from the network entity 105-b via the second serving cell. For example, an RRC configuration of a TCI-uplink-state for the second serving cell may be enhanced to include the directional information 225-b. As such, in some cases, the RRC configured TCI-uplink-state for the second serving cell may include a reference source that may include uplink-AoA information estimated from SRSs 220 transmitted by the UE 115-a via the first serving cell. In some other cases, the RRC configured TCI-uplink-state for the second serving cell may include a reference source including at least one SRS resource or SRS port used to transmit the SRSs 220 via the first serving cell that may indicate strong LoS information or strong NLoS information in the directional information 225-b. The LoS or NLoS information may include the uplink transmit spatial filters associated with the SRS resources or SRS ports indicated in the directional information 225-b. Therefore, the UE 115-a may be indicated with the TCI-uplink-state enhanced with the directional information 225-b and when the UE 115-a switches TCI states the uplink transmit spatial filters may be aligned in accordance to the LoS or NLoS information indicated in the TCI-uplink-state configuration.

In addition, in some cases, the directional information 225 derived from the SRSs 220 transmitted by the UE 115-a via the first serving cell may actually be derived from one or more serving cells. For example, the UE 115-a may transmit the SRSs 220 via the one or more serving cells including a first serving cell using the first frequency range and a third serving cell using a third frequency range that is different than both the first frequency range and the second frequency range. As such, the directional information 225 may include uplink-AoA information and SRIs for the LoS or NLoS information which may be derived from the one or more serving cells. Further, a MAC-CE message activating an uplink TCI state change may be enhanced to include at least two TCI-uplink-states, based on the one or more serving cells, for a single activated TCI codepoint. For NLoS information, the UE 115-a may be expected to avoid using the uplink transmit spatial filters leading towards the NLoS directions (e.g., the channel propagation direction 240-a or the channel propagation direction 240-b) included in the TCI-uplink-state codepoint, where the NLoS information may be derived from the one or more serving cells used by the UE 115-a to transmit the SRSs 220. For the LoS information, the MAC-CE message activating the TCI state change or the DCI message activating the TCI state change may select one of the one or more serving cells. That is the message may indicate for the UE 115-a to align uplink transmit spatial filters for the beams of the set of beams 210 in accordance with the LoS information from the selected serving cell of the one or more serving cells.

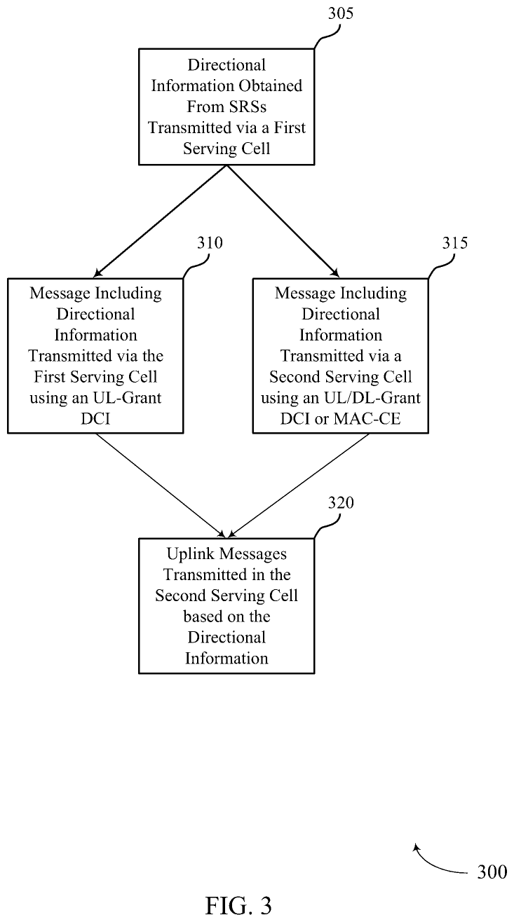

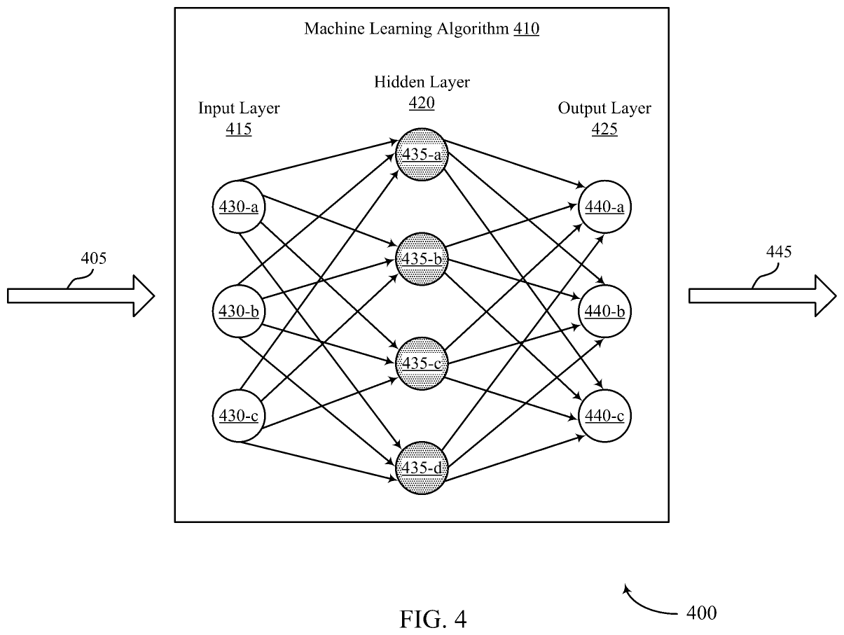

Further, as described herein, such indication of the directional information 225 may be received via the first serving cell (e.g., the directional information 225-a) or via the second serving cell (e.g., the directional information 225-b). Further description of such indications may be described herein with reference to FIG. 3. Additionally, descriptions of the UE 115-a receiving the directional information 225 to aid in performing beam prediction procedures using machine learning or AI procedures may be described with reference to FIGS. 3 and 4

FIG. 3 shows an example of a flowchart 300 that supports cross frequency range information for beam prediction in accordance with one or more aspects of the present disclosure. In some examples, the flowchart 300 may implement or be implemented by the wireless communications system 100 or the wireless communications system 200. In the following description of the flowchart 300, the operations may be performed in different orders or at different times. Some operations may also be left out of the flowchart 300, or other operations may be added.

At 305, a UE 115 may transmit SRS to a first network entity 105 via a first serving cell using a first frequency range. In some cases, the first network entity 105 may determine directional information including LoS or NLoS information based on SRSs measurements at the first network entity 105. In some other cases, the first network entity 105 of the first serving cell may transmit the SRS measurements or the directional information to a second network entity 105 of a second serving cell using a second frequency range. In cases where the first network entity 105 transmits the SRS measurements to the second network entity 105, the second network entity 105 may determine the directional information based on SRSs transmitted to the first network entity via the first serving cell.

At 310, the UE 115 may receive a control message indicating the directional information from the first serving cell. In such cases, when the UE 115 receives the directional information from the first serving cell, the UE 115 may determine the uplink transmit beams for transmitting uplink messages in the second serving cell. In some examples, the UE 115 may determine the uplink transmit beam via a beam prediction procedure or by beam sweeping the resources indicating in the LoS information or reducing the beam sweeping by avoiding the resources indicated in the NLoS information. For example, when the UE 115 may receive the control message indicating the directional information via a DCI message based on an uplink-grant DCI that schedules an uplink message (e.g., a PUSCH) transmission via the second serving cell.

At 315, the UE 115 may receive a control message indicating the directional information from the second serving cell. In such cases, when the UE 115 receives the directional information from the second serving cell, the second network entity 105 may have more control of the uplink transmit beam selection for communications by the UE 115 via the second serving cell. For example, when the UE 115 may receive the control message indicating the directional information via a DCI message based on an downlink-grant DCI indicating an uplink TCI-state change the LoS or NLoS information may be part of TCI-state configuration. In some examples, the control message indicating the directional information may be received via an uplink-grant DCI that schedules an uplink message (e.g., a PUSCH) transmission via the second serving cell, where the LoS or NLoS information may be a part of an SRI or a transmit precoder matrix indicator (TPMI).

At 310 or 315, when the UE 115 receives the directional information via the first serving cell or via the second serving cell, the UE 115 may receive an RRC message prior to receiving the directional information indicating that the directional information may be derived on the first serving cell. In some cases, control message indicating the directional information may also be indicated via an MAC-CE message. Additionally, or alternatively, the UE 115 may receive the MAC-CE message via the second serving cell and the MAC-CE message may include a serving cell identifier (ID) indicating the serving cell the SRS that the directional information may have been derived from (e.g., the first serving cell).

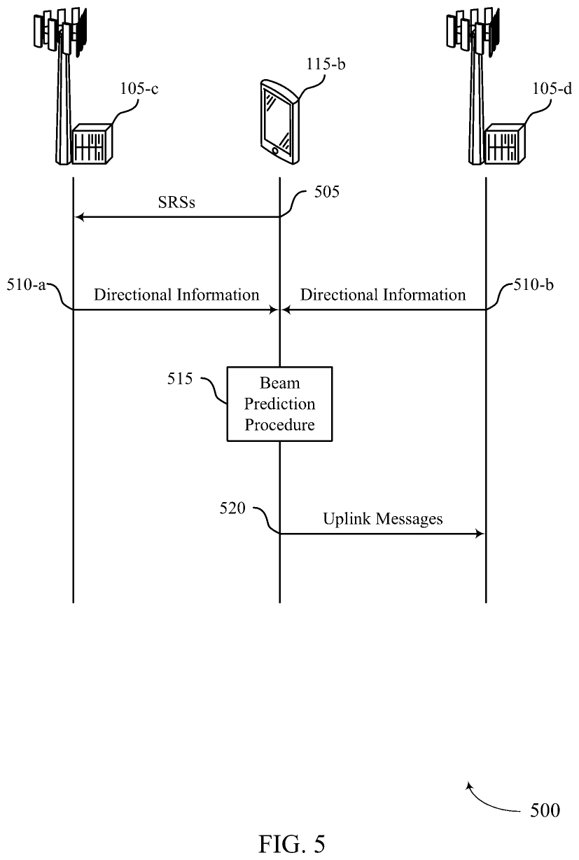

At 320, the UE 115 may transmit one or more uplink messages (e.g., SRSs, PUCCH messages, or PUSCH messages) via the second serving cell. The UE 115 may transmit the uplink messages using an uplink transmit beam identified or predicted via the directional information received from the first serving cell or from the second serving cell. As such, the one or more uplink messages may be transmitted based on and in accordance with the directional information indicated via the first serving cell or via the second serving cell. Further description of the beam prediction procedure may be described with reference to FIG. 4. Additionally, or alternatively, further descriptions of a UE 115 receiving a control message indicating directional information derived on SRSs transmitted by the UE 115 via the first serving cell and the UE 115 transmitting the uplink messages via the second serving cell in accordance with the directional information may be described with reference to FIG. 5.

FIG. 4 shows an example of a machine learning diagram 400 that supports beam pair information reporting in accordance with one or more aspects of the present disclosure. The machine learning process may be implemented by the wireless communications system 100 or the wireless communications system 200 with reference to FIGS. 1 and 2. For example, the machine learning diagram 400 may be implemented at a network entity 105, or a UE 115, or both as described with reference to FIGS. 1 and 2.

The machine learning diagram 400 may include a machine learning algorithm 410. As illustrated, the machine learning algorithm 410 may be an example of a neural network, such as a feed forward (FF) or deep feed forward (DFF) neural network, a recurrent neural network (RNN), a long/short term memory (LSTM) neural network, or any other type of neural network. However, any other machine learning algorithms may be supported. For example, the machine learning algorithm 410 may implement a nearest neighbor algorithm, a linear regression algorithm, a Naïve Bayes algorithm, a random forest algorithm, or any other machine learning algorithm. Furthermore, the machine learning diagram 400 may involve supervised learning, unsupervised learning, semi-supervised learning, reinforcement learning, or any combination thereof.

The machine learning algorithm 410 may include an input layer 415, one or more hidden layers 420, and an output layer 425. In a fully connected neural network with one hidden layer 420, each hidden layer node 435 may receive a value from each input layer node 430 as input, where each input may be weighted. These neural network weights may be based on a cost function that is revised during training of the machine learning algorithm 410. Similarly, each output layer node 440 may receive a value from each hidden layer node 435 as input, where the inputs are weighted. If post-deployment training (e.g., online training) is supported, memory may be allocated to store errors and/or gradients for reverse matrix multiplication. These errors and/or gradients may support updating the machine learning algorithm 410 based on output feedback. raining the machine learning algorithm 410 may support computation of the weights (e.g., connecting the input layer nodes 430 to the hidden layer nodes 435 and the hidden layer nodes 435 to the output layer nodes 440) to map an input pattern to a desired output outcome. This training may result in a device-specific machine learning algorithm 410 based on the historic application data and data transfer for a specific network entity 105 or UE 115.

In some examples, input values 405 may be sent to the machine learning algorithm 410 for processing. Such input values 405 may include directional information including channel propagation characteristics between a UE 115 and a network entity 105, where the directional information may be based on SRSs transmitted from the UE 115 using a set of beams. In some examples, preprocessing may be performed according to a sequence of operations on the input values 405 such that the input values 405 may be in a format that is compatible with the machine learning algorithm 410. The input values 405 may be converted into a set of k input layer nodes 430 at the input layer 415. In some cases, different measurements may be input at different input layer nodes 430 of the input layer 415. Some input layer nodes 430 may be assigned default values (e.g., values of 0) if the quantity of input layer nodes 430 exceeds the quantity of inputs corresponding to the input values 405. As illustrated, the input layer 415 may include three input layer nodes 430-a, 430-b, and 430-c. However, it is to be understood that the input layer 415 may include any quantity of input layer nodes 430 (e.g., 20 input nodes).

The machine learning algorithm 410 may convert the input layer 415 to a hidden layer 420 based on a quantity of input-to-hidden weights between the k input layer nodes 430 and the n hidden layer nodes 435. The machine learning algorithm 410 may include any quantity of hidden layers 420 as intermediate steps between the input layer 415 and the output layer 425. Additionally, each hidden layer 420 may include any quantity of nodes. For example, as illustrated, the hidden layer 420 may include four hidden layer nodes 435-a, 435-b, 435-c, and 435-d. However, it is to be understood that the hidden layer 420 may include any quantity of hidden layer nodes 435 (e.g., 10 input nodes). In a fully connected neural network, each node in a layer may be based on each node in the previous layer. For example, the value of hidden layer node 435-a may be based on the values of input layer nodes 430-a, 430-b, and 430-c (e.g., with different weights applied to each node value).

The machine learning algorithm 410 may determine values for the output layer nodes 440 of the output layer 425 following one or more hidden layers 420. For example, the machine learning algorithm 410 may convert the hidden layer 420 to the output layer 425 based on a quantity of hidden-to-output weights between the n hidden layer nodes 435 and the m output layer nodes 440. In some cases, n=m. Each output layer node 440 may correspond to a different output value 445 of the machine learning algorithm 410. The output values 445 may indicate one or more beam pair predictions, such that the network entity (e.g., using the machine learning algorithm 410) may indicate such predictions to a UE. As illustrated, the machine learning algorithm 410 may include three output layer nodes 440-a, 440-b, and 440-c, supporting three different threshold values. However, it is to be understood that the output layer 425 may include any quantity of output layer nodes 440. In some examples, post-processing may be performed on the output values 445 according to a sequence of operations such that the output values 445 may be in a format that is compatible with reporting the output values 445.

In this way, the network entity may receive the report from the UE and input the non-zero values of the report into the machine learning algorithm 410 as input values 405. The network entity may use the machine learning algorithm to determine one or more output values 445, where such output values 445 indicate uplink beams for the UE for subsequent communications. As such, the network entity may utilize the machine learning algorithm 410 to perform beam prediction procedures efficiently and accurately.

FIG. 5 shows an example of a process flow 500 that supports cross frequency range information for beam prediction in accordance with one or more aspects of the present disclosure. In some examples, the process flow 500 may implement or be implemented by the wireless communications system 100 or the wireless communications system 200. For example, the process flow 500 may include a UE 115-b, a network entity 105-c, and a network entity 105-d which may be examples of devices described herein with reference to FIG. 1

In the following description of the process flow 500, the operations between the UE 115-b, the network entity 105-c, and the network entity 105-d may be performed in different orders or at different times. Some operations may also be left out of the process flow 500, or other operations may be added. Although the UE 115-b, the network entity 105-c, and the network entity 105-d are shown performing the operations of the process flow 500, some aspects of some operations may also be performed by one or more other wireless devices.

At 505, the UE 115-b may transmit, to the network entity 105-c, a set of SRSs using a set of beams of the UE 115-b, via a first serving cell that supports communications for the UE 115-b using a first frequency range. In some cases, the UE 115-b may transmit the set of SRSs via the first serving cell via a first set of frequency resources of the first frequency range. In some examples, the UE 115-b may transmit the set of SRSs using the set of beams of the UE 115-b via the first serving cell and via a third serving cell that supports communications for the UE 115-b using a third frequency range different from both the first frequency rand and a second frequency range.

At 510-a, the UE 115-b may receive a control signal from the network entity 105-c or at 510-b, the UE 115-b may receive the control signal from the network entity 105-d. The control signal may include directional information for the UE 115-b based on channel propagation characteristics between the UE 115-b and the network entity 105-c. The channel propagation characteristics may be based on the set of SRSs transmitted by the UE 115-b via the first serving cell. In some cases, the UE 115-b may receive the control signal including the directional information based on estimated uplink AoA information. The AoA information may be based on the set of SRSs transmitted by the UE 115-b via the first serving cell.

In some cases, the network entity 105-c may transmit the channel propagation characteristics between the UE 115-b and the network entity 105-c to the network entity 105-d. As such, in some examples, the UE 115-b may receive the control signal including the directional information via the first serving cell using the first frequency range or via a second serving cell using the second frequency range. In some cases, the UE 115-b may receive the directional message via a DCI message or a MAC-CE message. For example, when receiving the DCI message via the first serving cell, the DCI may include an uplink grant that may schedule a transmission of an uplink message via the second serving cell. Additionally, or alternatively, the control signal including the directional information may indicate one or more SRS resources or one or more SRS ports used for the transmission of the SRSs.

In some examples, the UE 115-b may receive DCI message via the second serving cell. In some cases, the DCI message may include a downlink grant indicating a TCI state change, the TCI state change indicating the directional information. In some other cases, the DCI message may include an uplink grant that may schedule a transmission of an uplink message via the second serving cell where the DCI may include an SRI or a TPMI indicating the directional information. Additionally, or alternatively, when the UE 115-b receives the control signal via the second serving cell, the control signal may comprise an uplink TCI state configuration including the directional information based on the set of SRS transmitted by the UE 115-b via the first serving cell.

In some other examples, the UE 115-b may receive the MAC-CE including the directional information via the first serving cell or via the first serving cell and the MAC-CE may indicate a serving cell ID associated with the first serving cell. That is, the MAC-CE may indicate a serving cell ID associated with the serving cell that the UE 115-b used for transmitting the SRSs. In some cases, the UE 115-b may receive an RRC message indicating that the directional information may be based on the SRS transmitted by the UE 115-b via the first serving cell, which may be received via the first serving cell or via the second serving cell.

At 515, based on the directional information, the UE 115-b may perform a beam prediction procedure to predict an uplink beam of the UE 115-b for communicating via the second serving cell that may be different than the first serving cell. At 520, the UE 115-b may transmit, using the predicted uplink beam of the UE 115-b, one or more uplink messages via the second serving cell using the second frequency range that may be different than the first frequency range. In some cases, the second frequency range used for transmitting the one or more uplink messages may be a higher frequency range than the first frequency range. In some other cases, the UE 115-b may transmit the one or more uplink messages via the second serving cell may use a second set of frequency resources of the second frequency range.

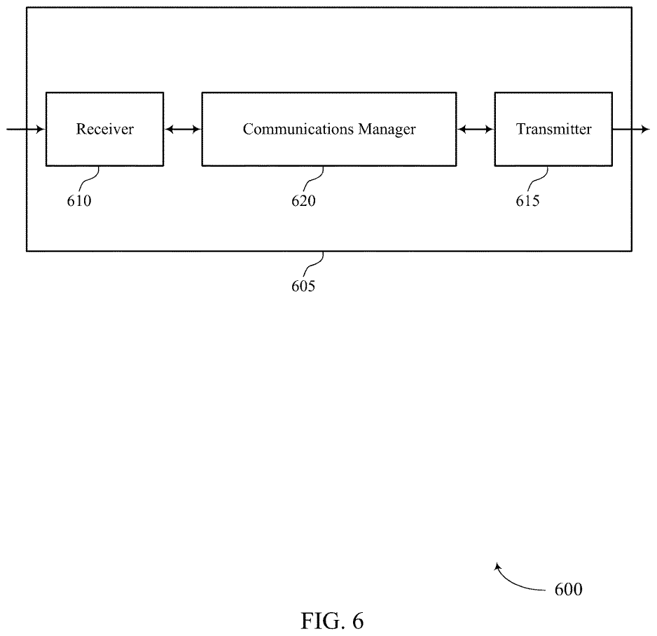

FIG. 6 shows a block diagram 600 of a device 605 that supports cross frequency range information for beam prediction in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to cross frequency range information for beam prediction). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to cross frequency range information for beam prediction). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of cross frequency range information for beam prediction as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at UE in accordance with examples as disclosed herein. For example, the communications manager 620 is capable of, configured to, or operable to support a means for transmitting, using a set of multiple beams of the UE, a set of multiple SRSs via a first serving cell that supports communications for the UE using a first frequency range. The communications manager 620 is capable of, configured to, or operable to support a means for receiving a control signal including directional information for the UE the directional information based on channel propagation characteristics between the UE and a network entity, where the channel propagation characteristics are based on the set of multiple SRSs transmitted via the first serving cell. The communications manager 620 is capable of, configured to, or operable to support a means for performing, based on the directional information, a beam prediction procedure to predict an uplink beam of the UE for communicating via a second serving cell different from the first serving cell. The communications manager 620 is capable of, configured to, or operable to support a means for transmitting, using the uplink beam of the UE, one or more uplink messages via the second serving cell using a second frequency range different from the first frequency range based on the beam prediction procedure.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for predicting uplink beams based on directional information for reduced processing, reduced power consumption, and more efficient utilization of communication resources.

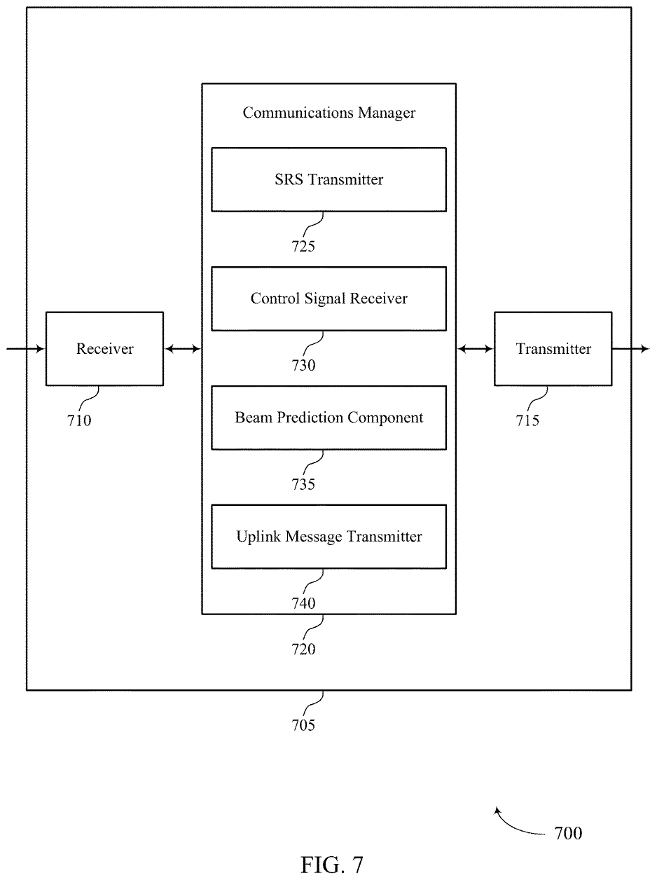

FIG. 7 shows a block diagram 700 of a device 705 that supports cross frequency range information for beam prediction in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to cross frequency range information for beam prediction). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to cross frequency range information for beam prediction). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of cross frequency range information for beam prediction as described herein. For example, the communications manager 720 may include an SRS transmitter 725, a control signal receiver 730, a beam prediction component 735, an uplink message transmitter 740, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at UE in accordance with examples as disclosed herein. The SRS transmitter 725 is capable of, configured to, or operable to support a means for transmitting, using a set of multiple beams of the UE, a set of multiple SRSs via a first serving cell that supports communications for the UE using a first frequency range. The control signal receiver 730 is capable of, configured to, or operable to support a means for receiving a control signal including directional information for the UE the directional information based on channel propagation characteristics between the UE and a network entity, where the channel propagation characteristics are based on the set of multiple SRSs transmitted via the first serving cell. The beam prediction component 735 is capable of, configured to, or operable to support a means for performing, based on the directional information, a beam prediction procedure to predict an uplink beam of the UE for communicating via a second serving cell different from the first serving cell. The uplink message transmitter 740 is capable of, configured to, or operable to support a means for transmitting, using the uplink beam of the UE, one or more uplink messages via the second serving cell using a second frequency range different from the first frequency range based on the beam prediction procedure.

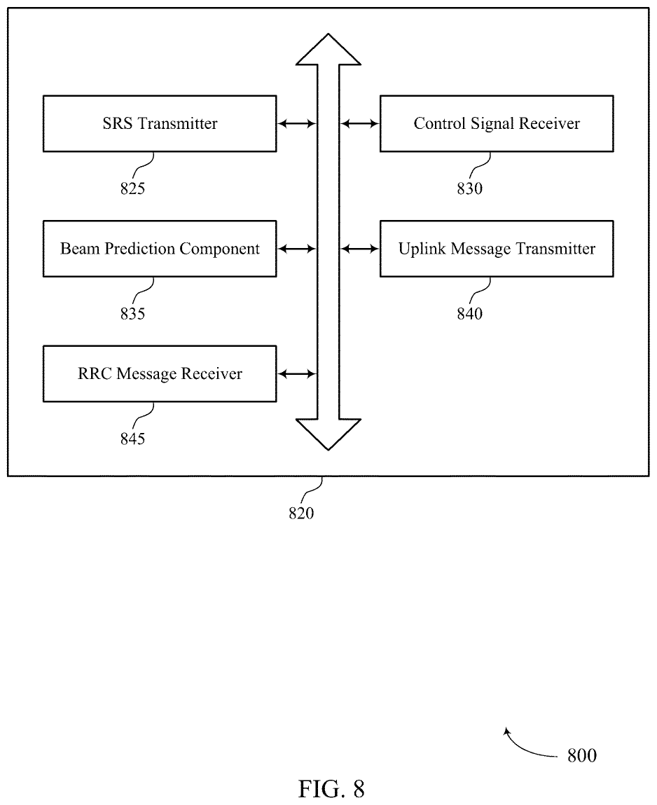

FIG. 8 shows a block diagram 800 of a communications manager 820 that supports cross frequency range information for beam prediction in accordance with one or more aspects of the present disclosure. The communications manager 820 may be an example of aspects of a communications manager 620, a communications manager 720, or both, as described herein. The communications manager 820, or various components thereof, may be an example of means for performing various aspects of cross frequency range information for beam prediction as described herein. For example, the communications manager 820 may include an SRS transmitter 825, a control signal receiver 830, a beam prediction component 835, an uplink message transmitter 840, an RRC message receiver 845, or any combination thereof. Each of these components may communicate, directly or indirectly, with one another (e.g., via one or more buses).

The communications manager 820 may support wireless communications at UE in accordance with examples as disclosed herein. The SRS transmitter 825 is capable of, configured to, or operable to support a means for transmitting, using a set of multiple beams of the UE, a set of multiple SRSs via a first serving cell that supports communications for the UE using a first frequency range. The control signal receiver 830 is capable of, configured to, or operable to support a means for receiving a control signal including directional information for the UE the directional information based on channel propagation characteristics between the UE and a network entity, where the channel propagation characteristics are based on the set of multiple SRSs transmitted via the first serving cell. The beam prediction component 835 is capable of, configured to, or operable to support a means for performing, based on the directional information, a beam prediction procedure to predict an uplink beam of the UE for communicating via a second serving cell different from the first serving cell. The uplink message transmitter 840 is capable of, configured to, or operable to support a means for transmitting, using the uplink beam of the UE, one or more uplink messages via the second serving cell using a second frequency range different from the first frequency range based on the beam prediction procedure.

In some examples, to support transmitting the one or more uplink messages, the uplink message transmitter 840 is capable of, configured to, or operable to support a means for transmitting, using the uplink beam of the UE, the one or more uplink messages via the second serving cell using the second frequency range, where the second frequency range is higher in frequency than the first frequency range.

In some examples, the SRS transmitter 825 is capable of, configured to, or operable to support a means for transmitting the set of multiple SRSs via the first serving cell via a first set of frequency resources of the first frequency range. In some examples, the uplink message transmitter 840 is capable of, configured to, or operable to support a means for transmitting the one or more uplink messages via the second serving cell using a second set of frequency resources of the second frequency range.

In some examples, to support receiving the control signal, the control signal receiver 830 is capable of, configured to, or operable to support a means for receiving, via the first serving cell using the first frequency range or via the second serving cell using the second frequency range, a DCI message or a MAC-CE message that includes the directional information for the UE.

In some examples, to support receiving the DCI message via the first serving cell, the control signal receiver 830 is capable of, configured to, or operable to support a means for receiving the DCI message including an uplink grant that schedules transmission of an uplink message via the second serving cell, where the one or more uplink messages includes the uplink message.

In some examples, to support receiving the DCI message via the second serving cell, the control signal receiver 830 is capable of, configured to, or operable to support a means for receiving the DCI message including a downlink grant indicating a transmission configuration indication state change, the transmission configuration indication state change indicating the directional information.

In some examples, to support receiving the DCI message via the second serving cell, the control signal receiver 830 is capable of, configured to, or operable to support a means for receiving, via the second serving cell, the DCI message including an uplink grant scheduling a transmission of an uplink message via the second serving cell, the one or more uplink messages including the uplink message, the DCI including a SRS resource indicator indicating the directional information or a transmit precoder matrix indicator indicating the directional information.

In some examples, the RRC message receiver 845 is capable of, configured to, or operable to support a means for receiving, before reception of the control signal, an RRC message indicating that the directional information is based on the set of multiple SRSs transmitted via the first serving cell.

In some examples, to support receiving the MAC-CE message via the first serving cell or via the second serving cell, the control signal receiver 830 is capable of, configured to, or operable to support a means for receiving the MAC-CE message including the directional information, where the MAC-CE message indicates a serving cell identifier associated with the first serving cell.

In some examples, to support receiving the control signal, the control signal receiver 830 is capable of, configured to, or operable to support a means for receiving the control signal including the directional information based on estimated uplink angle of arrival information, the estimated uplink angle of arrival information based on the set of multiple SRSs transmitted via the first serving cell.

In some examples, to support receiving the control signal, the control signal receiver 830 is capable of, configured to, or operable to support a means for receiving the control signal including the directional information that indicates one or more SRS resources used for transmission of the set of multiple SRSs or one or more SRS ports used for transmission of the set of multiple SRSs.

In some examples, to support receiving the control signal, the control signal receiver 830 is capable of, configured to, or operable to support a means for receiving, via the second serving cell, the control signal including an uplink transmission configuration indication state configuration, the uplink transmission configuration indication state configuration including the directional information that is based on the set of multiple SRSs transmitted via the first serving cell.

In some examples, the SRS transmitter 825 is capable of, configured to, or operable to support a means for transmitting, using the set of multiple beams of the UE, the set of multiple SRSs via the first serving cell and via a third serving cell that supports communications for the UE using a third frequency range different from both the first frequency range and the second frequency range.

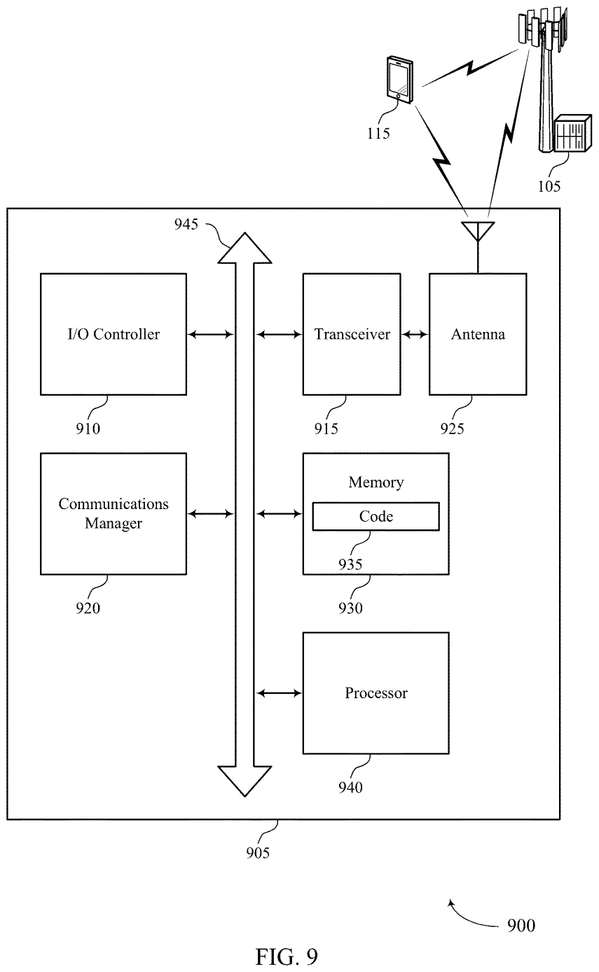

FIG. 9 shows a diagram of a system 900 including a device 905 that supports cross frequency range information for beam prediction in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting cross frequency range information for beam prediction). For example, the device 905 or a component of the device 905 may include a processor 940 and memory 930 coupled with or to the processor 940, the processor 940 and memory 930 configured to perform various functions described herein.

The communications manager 920 may support wireless communications at UE in accordance with examples as disclosed herein. For example, the communications manager 920 is capable of, configured to, or operable to support a means for transmitting, using a set of multiple beams of the UE, a set of multiple SRSs via a first serving cell that supports communications for the UE using a first frequency range. The communications manager 920 is capable of, configured to, or operable to support a means for receiving a control signal including directional information for the UE the directional information based on channel propagation characteristics between the UE and a network entity, where the channel propagation characteristics are based on the set of multiple SRSs transmitted via the first serving cell. The communications manager 920 is capable of, configured to, or operable to support a means for performing, based on the directional information, a beam prediction procedure to predict an uplink beam of the UE for communicating via a second serving cell different from the first serving cell. The communications manager 920 is capable of, configured to, or operable to support a means for transmitting, using the uplink beam of the UE, one or more uplink messages via the second serving cell using a second frequency range different from the first frequency range based on the beam prediction procedure.

By including or configuring the communications manager 920 in accordance with examples as described herein, the device 905 may support techniques for predicting uplink beams based on directional information for improved communication reliability, reduced latency, improved user experience related to reduced processing, reduced power consumption, more efficient utilization of communication resources, improved coordination between devices, longer battery life, and improved utilization of processing capability.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of cross frequency range information for beam prediction as described herein, or the processor 940 and the memory 930 may be otherwise configured to perform or support such operations.

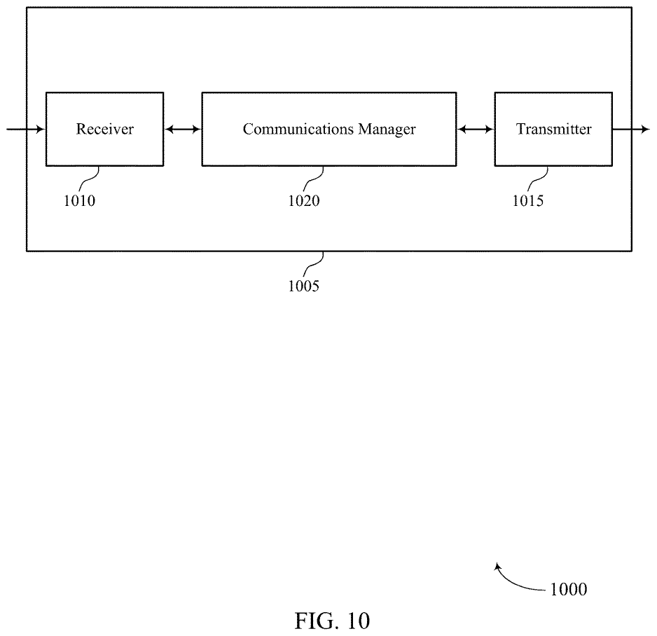

FIG. 10 shows a block diagram 1000 of a device 1005 that supports cross frequency range information for beam prediction in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of cross frequency range information for beam prediction as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a first network entity in accordance with examples as disclosed herein. For example, the communications manager 1020 is capable of, configured to, or operable to support a means for receiving, from a UE, a set of multiple SRSs via a first serving cell that supports communications with the UE using a first frequency range. The communications manager 1020 is capable of, configured to, or operable to support a means for transmitting a control signal including directional information to the UE via the first serving cell, the directional information based on channel propagation characteristics between the UE and the first network entity where the channel propagation characteristics are based on the set of multiple SRSs received via the first serving cell.

Additionally, or alternatively, the communications manager 1020 may support wireless communications at a first network entity in accordance with examples as disclosed herein. For example, the communications manager 1020 is capable of, configured to, or operable to support a means for receiving, from a second network entity, a message indicating channel propagation characteristics between a UE and the second network entity, the second network entity operating via a first serving cell using a first frequency range. The communications manager 1020 is capable of, configured to, or operable to support a means for transmitting a control signal including directional information to the UE via a second serving cell using a second frequency range different from the first frequency range, the directional information identified based on the message from the second network entity including the channel propagation characteristics between the UE and the second network entity via the first serving cell. The communications manager 1020 is capable of, configured to, or operable to support a means for receiving, one or more uplink messages, from an uplink beam of the UE, the one or more uplink messages received via the second serving cell using the second frequency range in accordance with the directional information.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for predicting uplink beams based on directional information for reduced processing, reduced power consumption, and more efficient utilization of communication resources.

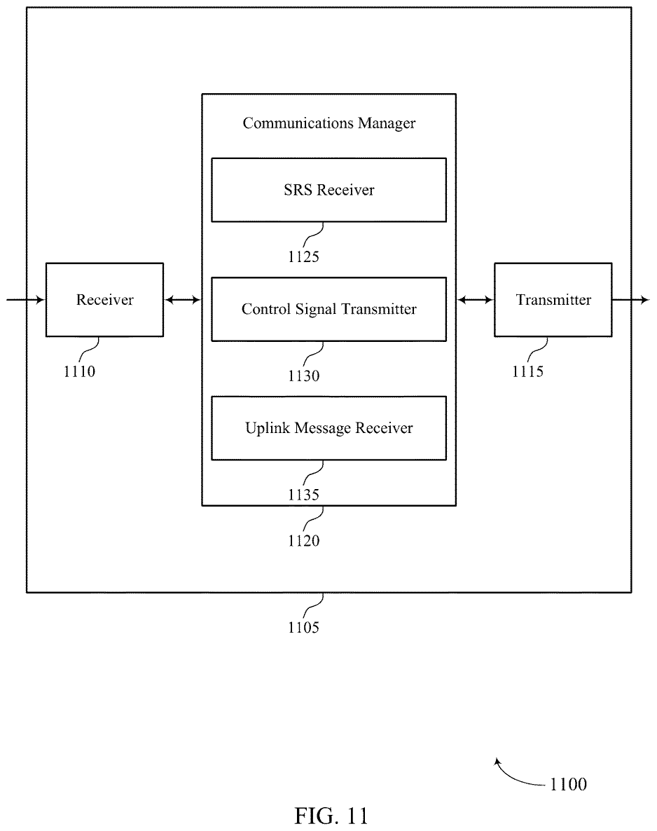

FIG. 11 shows a block diagram 1100 of a device 1105 that supports cross frequency range information for beam prediction in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of cross frequency range information for beam prediction as described herein. For example, the communications manager 1120 may include an SRS receiver 1125, a control signal transmitter 1130, an uplink message receiver 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications at a first network entity in accordance with examples as disclosed herein. The SRS receiver 1125 is capable of, configured to, or operable to support a means for receiving, from a UE, a set of multiple SRSs via a first serving cell that supports communications with the UE using a first frequency range. The control signal transmitter 1130 is capable of, configured to, or operable to support a means for transmitting a control signal including directional information to the UE via the first serving cell, the directional information based on channel propagation characteristics between the UE and the first network entity where the channel propagation characteristics are based on the set of multiple SRSs received via the first serving cell.

Additionally, or alternatively, the communications manager 1120 may support wireless communications at a first network entity in accordance with examples as disclosed herein. The SRS receiver 1125 is capable of, configured to, or operable to support a means for receiving, from a second network entity, a message indicating channel propagation characteristics between a UE and the second network entity, the second network entity operating via a first serving cell using a first frequency range. The control signal transmitter 1130 is capable of, configured to, or operable to support a means for transmitting a control signal including directional information to the UE via a second serving cell using a second frequency range different from the first frequency range, the directional information identified based on the message from the second network entity including the channel propagation characteristics between the UE and the second network entity via the first serving cell. The uplink message receiver 1135 is capable of, configured to, or operable to support a means for receiving, one or more uplink messages, from an uplink beam of the UE, the one or more uplink messages received via the second serving cell using the second frequency range in accordance with the directional information.

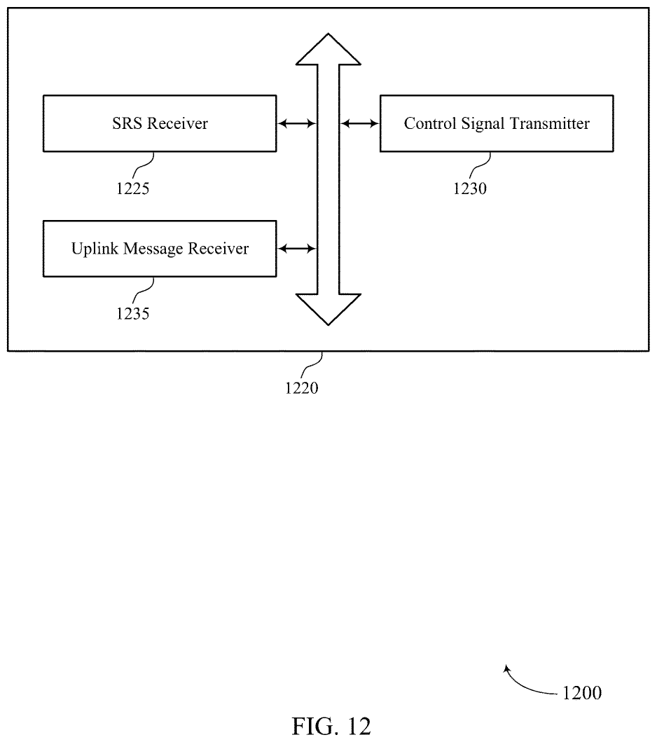

FIG. 12 shows a block diagram 1200 of a communications manager 1220 that supports cross frequency range information for beam prediction in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of cross frequency range information for beam prediction as described herein. For example, the communications manager 1220 may include an SRS receiver 1225, a control signal transmitter 1230, an uplink message receiver 1235, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications at a first network entity in accordance with examples as disclosed herein. The SRS receiver 1225 is capable of, configured to, or operable to support a means for receiving, from a UE, a set of multiple SRSs via a first serving cell that supports communications with the UE using a first frequency range. The control signal transmitter 1230 is capable of, configured to, or operable to support a means for transmitting a control signal including directional information to the UE via the first serving cell, the directional information based on channel propagation characteristics between the UE and the first network entity where the channel propagation characteristics are based on the set of multiple SRSs received via the first serving cell.

In some examples, the SRS receiver 1225 is capable of, configured to, or operable to support a means for receiving the set of multiple SRSs via the first serving cell via a set of frequency resources of the first frequency range.

In some examples, to support transmitting the control signal, the control signal transmitter 1230 is capable of, configured to, or operable to support a means for transmitting, via the first serving cell using the first frequency range, a DCI message or a MAC-CE message that includes the directional information for the UE.

In some examples, to support transmitting the DCI message via the first serving cell, the control signal transmitter 1230 is capable of, configured to, or operable to support a means for transmitting the DCI message including an uplink grant that schedules transmission of an uplink message via a second serving cell using a second frequency range.

In some examples, to support transmitting the control signal, the control signal transmitter 1230 is capable of, configured to, or operable to support a means for transmitting the control signal including the directional information that indicates one or more SRS resources used for receiving of the set of multiple SRSs or one or more SRS ports used for reception of the set of multiple SRSs.

In some examples, the SRS receiver 1225 is capable of, configured to, or operable to support a means for receiving, the set of multiple SRSs via the first serving cell and via a third serving cell that supports communication for the UE using a third frequency range different from the first frequency range.

Additionally, or alternatively, the communications manager 1220 may support wireless communications at a first network entity in accordance with examples as disclosed herein. In some examples, the SRS receiver 1225 is capable of, configured to, or operable to support a means for receiving, from a second network entity, a message indicating channel propagation characteristics between a UE and the second network entity, the second network entity operating via a first serving cell using a first frequency range. In some examples, the control signal transmitter 1230 is capable of, configured to, or operable to support a means for transmitting a control signal including directional information to the UE via a second serving cell using a second frequency range different from the first frequency range, the directional information identified based on the message from the second network entity including the channel propagation characteristics between the UE and the second network entity via the first serving cell. The uplink message receiver 1235 is capable of, configured to, or operable to support a means for receiving, one or more uplink messages, from an uplink beam of the UE, the one or more uplink messages received via the second serving cell using the second frequency range in accordance with the directional information.

In some examples, to support receiving the one or more uplink messages, the uplink message receiver 1235 is capable of, configured to, or operable to support a means for receiving, from the uplink beam of the UE, the one or more uplink messages via the second serving cell using the second frequency range, where the second frequency range is higher in frequency than the first frequency range.

In some examples, the uplink message receiver 1235 is capable of, configured to, or operable to support a means for receiving the one or more uplink messages via the second serving cell using a set of frequency resources of the second frequency range.

In some examples, to support transmitting the control signal, the control signal transmitter 1230 is capable of, configured to, or operable to support a means for transmitting, via the second serving cell using the second frequency range, a DCI message or a MAC-CE that includes the directional information for the UE.

In some examples, to support transmitting the DCI message via the second serving cell, the control signal transmitter 1230 is capable of, configured to, or operable to support a means for transmitting the DCI message including a downlink grant indicating a transmission configuration indication state change indicating the directional information.

In some examples, to support transmitting the DCI message via the second serving cell, the control signal transmitter 1230 is capable of, configured to, or operable to support a means for transmitting, via the second serving cell, the DCI message including an uplink grant scheduling a transmission of an uplink message via the second serving cell, the one or more uplink messages including the uplink message, the DCI including a SRS resource indicator indicating the directional information or a transmit precoder matrix indicator indicating the directional information.

In some examples, to support transmitting the control signal, the control signal transmitter 1230 is capable of, configured to, or operable to support a means for transmitting, via the second serving cell, the control signal including an uplink transmission configuration indication state configuration, the uplink transmission configuration indication state configuration including the directional information.

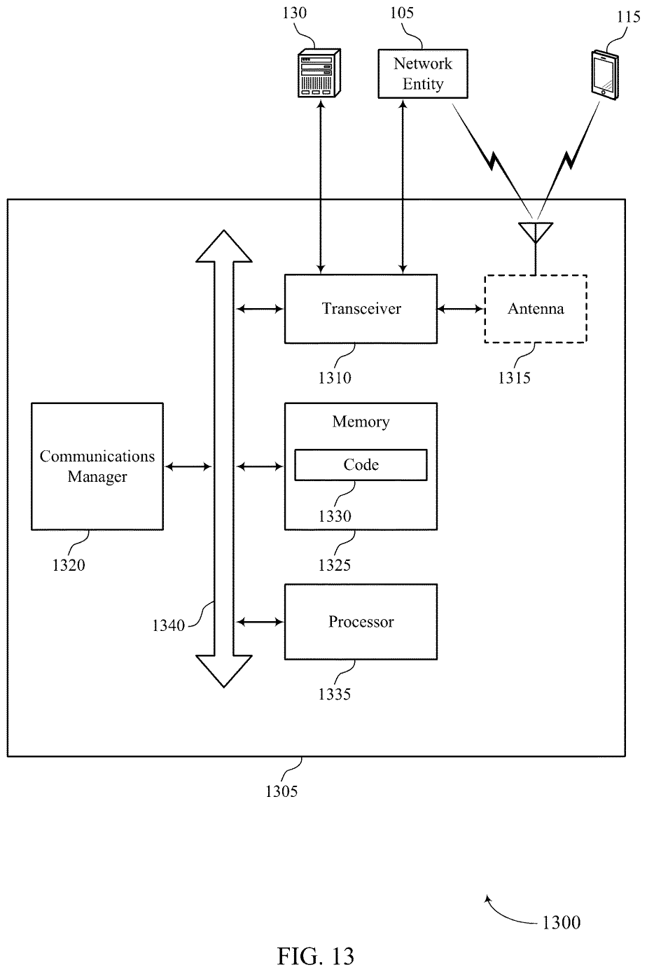

FIG. 13 shows a diagram of a system 1300 including a device 1305 that supports cross frequency range information for beam prediction in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or memory components (for example, the processor 1335, or the memory 1325, or both), may be included in a chip or chip assembly that is installed in the device 1305. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting cross frequency range information for beam prediction). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305. The processor 1335 may be any one or more suitable processors capable of executing scripts or instructions of one or more software programs stored in the device 1305 (such as within the memory 1325). In some implementations, the processor 1335 may be a component of a processing system. A processing system may generally refer to a system or series of machines or components that receives inputs and processes the inputs to produce a set of outputs (which may be passed to other systems or components of, for example, the device 1305). For example, a processing system of the device 1305 may refer to a system including the various other components or subcomponents of the device 1305, such as the processor 1335, or the transceiver 1310, or the communications manager 1320, or other components or combinations of components of the device 1305. The processing system of the device 1305 may interface with other components of the device 1305, and may process information received from other components (such as inputs or signals) or output information to other components. For example, a chip or modem of the device 1305 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1305 may transmit information output from the chip or modem. Additionally, or alternatively, in some implementations, the one or more interfaces may refer to an interface between the processing system of the chip or modem and a receiver, such that the device 1305 may obtain information or signal inputs, and the information may be passed to the processing system. A person having ordinary skill in the art will readily recognize that a first interface also may obtain information or signal inputs, and a second interface also may output information or signal outputs.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communications at a first network entity in accordance with examples as disclosed herein. For example, the communications manager 1320 is capable of, configured to, or operable to support a means for receiving, from a UE, a set of multiple SRSs via a first serving cell that supports communications with the UE using a first frequency range. The communications manager 1320 is capable of, configured to, or operable to support a means for transmitting a control signal including directional information to the UE via the first serving cell, the directional information based on channel propagation characteristics between the UE and the first network entity where the channel propagation characteristics are based on the set of multiple SRSs received via the first serving cell.

Additionally, or alternatively, the communications manager 1320 may support wireless communications at a first network entity in accordance with examples as disclosed herein. For example, the communications manager 1320 is capable of, configured to, or operable to support a means for receiving, from a second network entity, a message indicating channel propagation characteristics between a UE and the second network entity, the second network entity operating via a first serving cell using a first frequency range. The communications manager 1320 is capable of, configured to, or operable to support a means for transmitting a control signal including directional information to the UE via a second serving cell using a second frequency range different from the first frequency range, the directional information identified based on the message from the second network entity including the channel propagation characteristics between the UE and the second network entity via the first serving cell. The communications manager 1320 is capable of, configured to, or operable to support a means for receiving, one or more uplink messages, from an uplink beam of the UE, the one or more uplink messages received via the second serving cell using the second frequency range in accordance with the directional information.

By including or configuring the communications manager 1320 in accordance with examples as described herein, the device 1305 may support techniques for predicting uplink beams based on directional information for improved communication reliability, reduced latency, improved user experience related to reduced processing, reduced power consumption, more efficient utilization of communication resources, improved coordination between devices, longer battery life, and improved utilization of processing capability.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, the processor 1335, the memory 1325, the code 1330, or any combination thereof. For example, the code 1330 may include instructions executable by the processor 1335 to cause the device 1305 to perform various aspects of cross frequency range information for beam prediction as described herein, or the processor 1335 and the memory 1325 may be otherwise configured to perform or support such operations.

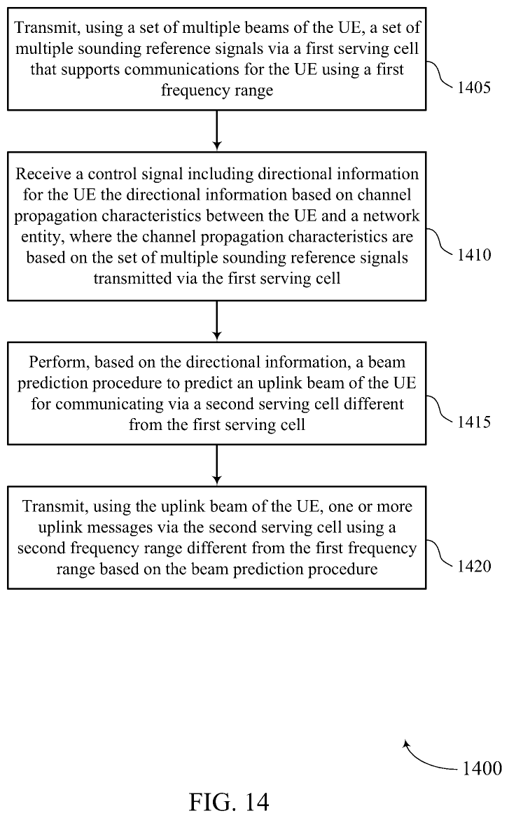

FIG. 14 shows a flowchart illustrating a method 1400 that supports cross frequency range information for beam prediction in accordance with aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include transmitting, using a set of multiple beams of the UE, a set of multiple SRSs via a first serving cell that supports communications for the UE using a first frequency range. The operations of block 1405 may be performed in accordance with examples as disclosed herein. In some examples, aspects of the operations of 1405 may be performed by an SRS transmitter 825 as described with reference to FIG. 8.

At 1410, the method may include receiving a control signal including directional information for the UE the directional information based on channel propagation characteristics between the UE and a network entity, where the channel propagation characteristics are based on the set of multiple SRSs transmitted via the first serving cell. The operations of block 1410 may be performed in accordance with examples as disclosed herein. In some examples, aspects of the operations of 1410 may be performed by a control signal receiver 830 as described with reference to FIG. 8.

At 1415, the method may include performing, based on the directional information, a beam prediction procedure to predict an uplink beam of the UE for communicating via a second serving cell different from the first serving cell. The operations of block 1415 may be performed in accordance with examples as disclosed herein. In some examples, aspects of the operations of 1415 may be performed by a beam prediction component 835 as described with reference to FIG. 8.

At 1420, the method may include transmitting, using the uplink beam of the UE, one or more uplink messages via the second serving cell using a second frequency range different from the first frequency range based on the beam prediction procedure. The operations of block 1420 may be performed in accordance with examples as disclosed herein. In some examples, aspects of the operations of 1420 may be performed by an uplink message transmitter 840 as described with reference to FIG. 8.

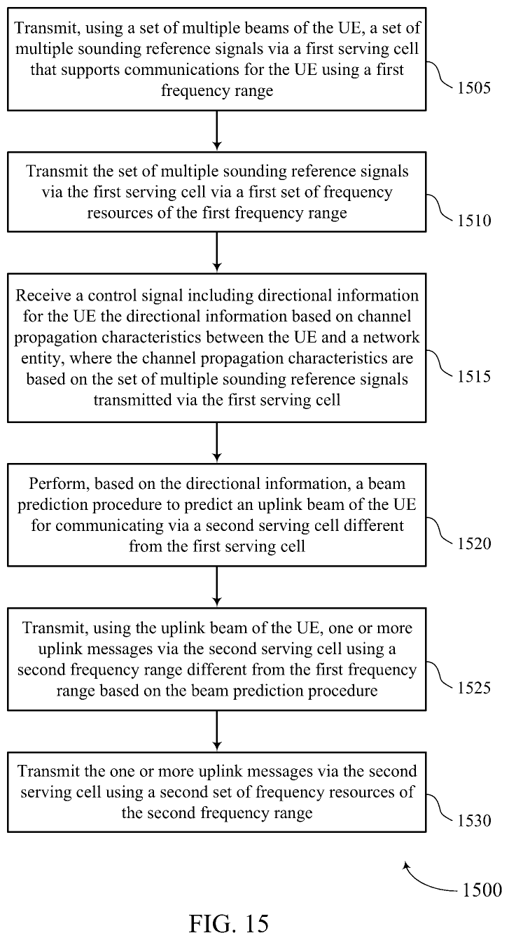

FIG. 15 shows a flowchart illustrating a method 1500 that supports cross frequency range information for beam prediction in accordance with aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include transmitting, using a set of multiple beams of the UE, a set of multiple SRSs via a first serving cell that supports communications for the UE using a first frequency range. The operations of block 1505 may be performed in accordance with examples as disclosed herein. In some examples, aspects of the operations of 1505 may be performed by an SRS transmitter 825 as described with reference to FIG. 8.

At 1510, the method may include transmitting the set of multiple SRSs via the first serving cell via a first set of frequency resources of the first frequency range. The operations of block 1510 may be performed in accordance with examples as disclosed herein. In some examples, aspects of the operations of 1510 may be performed by an SRS transmitter 825 as described with reference to FIG. 8.

At 1515, the method may include receiving a control signal including directional information for the UE the directional information based on channel propagation characteristics between the UE and a network entity, where the channel propagation characteristics are based on the set of multiple SRSs transmitted via the first serving cell. The operations of block 1515 may be performed in accordance with examples as disclosed herein. In some examples, aspects of the operations of 1515 may be performed by a control signal receiver 830 as described with reference to FIG. 8.

At 1520, the method may include performing, based on the directional information, a beam prediction procedure to predict an uplink beam of the UE for communicating via a second serving cell different from the first serving cell. The operations of block 1520 may be performed in accordance with examples as disclosed herein. In some examples, aspects of the operations of 1520 may be performed by a beam prediction component 835 as described with reference to FIG. 8.

At 1525, the method may include transmitting, using the uplink beam of the UE, one or more uplink messages via the second serving cell using a second frequency range different from the first frequency range based on the beam prediction procedure. The operations of block 1525 may be performed in accordance with examples as disclosed herein. In some examples, aspects of the operations of 1525 may be performed by an uplink message transmitter 840 as described with reference to FIG. 8.

At 1530, the method may include transmitting the one or more uplink messages via the second serving cell using a second set of frequency resources of the second frequency range. The operations of block 1530 may be performed in accordance with examples as disclosed herein. In some examples, aspects of the operations of 1530 may be performed by an uplink message transmitter 840 as described with reference to FIG. 8.

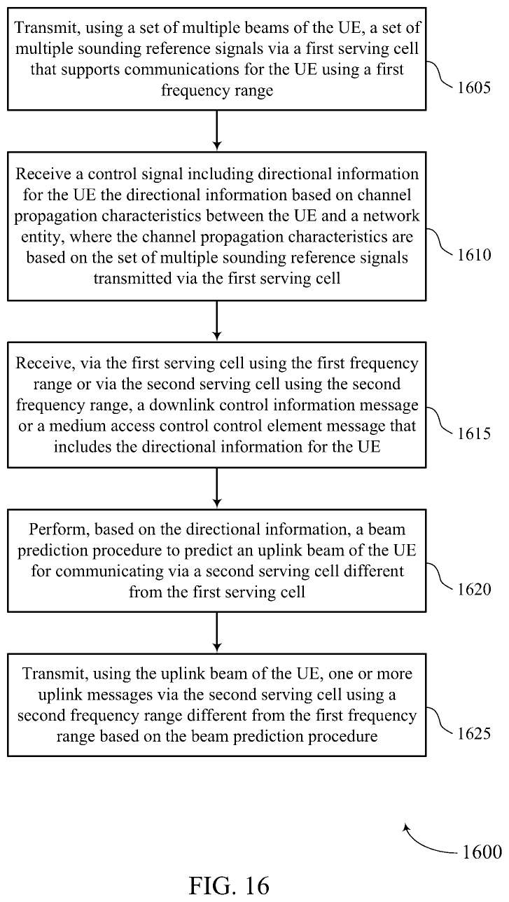

FIG. 16 shows a flowchart illustrating a method 1600 that supports cross frequency range information for beam prediction in accordance with aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include transmitting, using a set of multiple beams of the UE, a set of multiple SRSs via a first serving cell that supports communications for the UE using a first frequency range. The operations of block 1605 may be performed in accordance with examples as disclosed herein. In some examples, aspects of the operations of 1605 may be performed by an SRS transmitter 825 as described with reference to FIG. 8.

At 1610, the method may include receiving a control signal including directional information for the UE the directional information based on channel propagation characteristics between the UE and a network entity, where the channel propagation characteristics are based on the set of multiple SRSs transmitted via the first serving cell. The operations of block 1610 may be performed in accordance with examples as disclosed herein. In some examples, aspects of the operations of 1610 may be performed by a control signal receiver 830 as described with reference to FIG. 8.

At 1615, the method may include receiving, via the first serving cell using the first frequency range or via the second serving cell using the second frequency range, a DCI message or a MAC-CE message that includes the directional information for the UE. The operations of block 1615 may be performed in accordance with examples as disclosed herein. In some examples, aspects of the operations of 1615 may be performed by a control signal receiver 830 as described with reference to FIG. 8.

At 1620, the method may include performing, based on the directional information, a beam prediction procedure to predict an uplink beam of the UE for communicating via a second serving cell different from the first serving cell. The operations of block 1620 may be performed in accordance with examples as disclosed herein. In some examples, aspects of the operations of 1620 may be performed by a beam prediction component 835 as described with reference to FIG. 8.

At 1625, the method may include transmitting, using the uplink beam of the UE, one or more uplink messages via the second serving cell using a second frequency range different from the first frequency range based on the beam prediction procedure. The operations of block 1625 may be performed in accordance with examples as disclosed herein. In some examples, aspects of the operations of 1625 may be performed by an uplink message transmitter 840 as described with reference to FIG. 8.

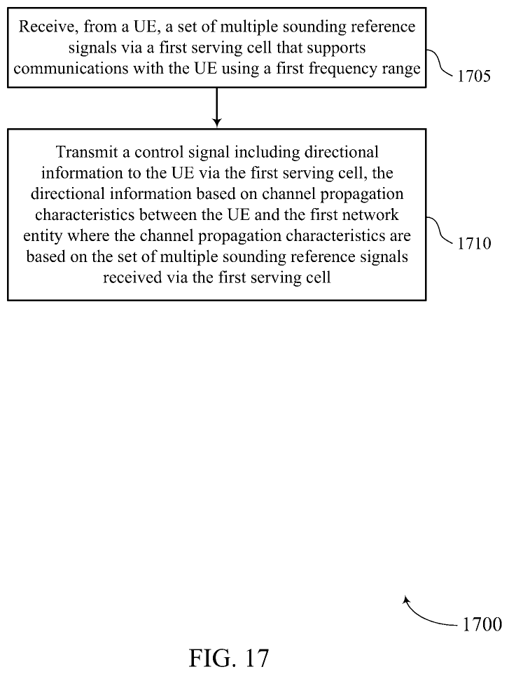

FIG. 17 shows a flowchart illustrating a method 1700 that supports cross frequency range information for beam prediction in accordance with aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include receiving, from a UE, a set of multiple SRSs via a first serving cell that supports communications with the UE using a first frequency range. The operations of block 1705 may be performed in accordance with examples as disclosed herein. In some examples, aspects of the operations of 1705 may be performed by an SRS receiver 1225 as described with reference to FIG. 12.

At 1710, the method may include transmitting a control signal including directional information to the UE via the first serving cell, the directional information based on channel propagation characteristics between the UE and the first network entity where the channel propagation characteristics are based on the set of multiple SRSs received via the first serving cell. The operations of block 1710 may be performed in accordance with examples as disclosed herein. In some examples, aspects of the operations of 1710 may be performed by a control signal transmitter 1230 as described with reference to FIG. 12.

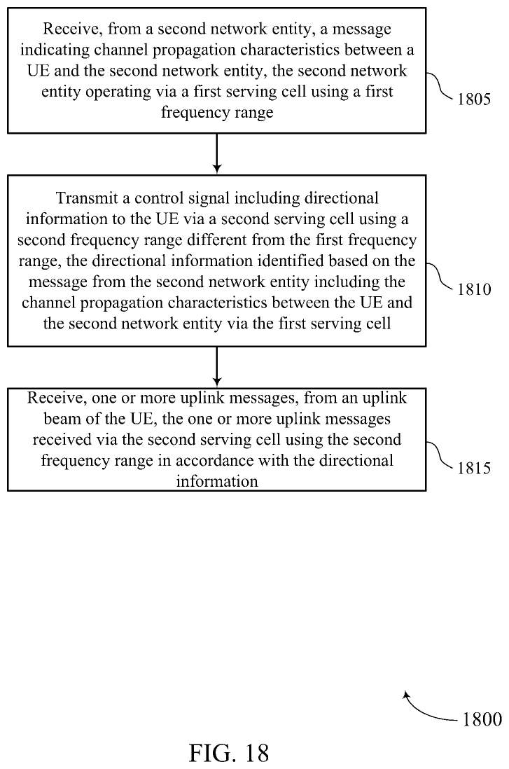

FIG. 18 shows a flowchart illustrating a method 1800 that supports cross frequency range information for beam prediction in accordance with aspects of the present disclosure. The operations of the method 1800 may be implemented by a network entity or its components as described herein. For example, the operations of the method 1800 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1805, the method may include receiving, from a second network entity, a message indicating channel propagation characteristics between a UE and the second network entity, the second network entity operating via a first serving cell using a first frequency range. The operations of block 1805 may be performed in accordance with examples as disclosed herein. In some examples, aspects of the operations of 1805 may be performed by an SRS receiver 1225 as described with reference to FIG. 12.

At 1810, the method may include transmitting a control signal including directional information to the UE via a second serving cell using a second frequency range different from the first frequency range, the directional information identified based on the message from the second network entity including the channel propagation characteristics between the UE and the second network entity via the first serving cell. The operations of block 1810 may be performed in accordance with examples as disclosed herein. In some examples, aspects of the operations of 1810 may be performed by a control signal transmitter 1230 as described with reference to FIG. 12.

At 1815, the method may include receiving, one or more uplink messages, from an uplink beam of the UE, the one or more uplink messages received via the second serving cell using the second frequency range in accordance with the directional information. The operations of block 1815 may be performed in accordance with examples as disclosed herein. In some examples, aspects of the operations of 1815 may be performed by an uplink message receiver 1235 as described with reference to FIG. 12.

The following provides an overview of aspects of the present disclosure:

Aspect 1: A method for wireless communications at UE, comprising: transmitting, using a plurality of beams of the UE, a plurality of SRSs via a first serving cell that supports communications for the UE using a first frequency range; receiving a control signal comprising directional information for the UE the directional information based at least in part on channel propagation characteristics between the UE and a network entity, wherein the channel propagation characteristics are based at least in part on the plurality of SRSs transmitted via the first serving cell; performing, based at least in part on the directional information, a beam prediction procedure to predict an uplink beam of the UE for communicating via a second serving cell different from the first serving cell; and transmitting, using the uplink beam of the UE, one or more uplink messages via the second serving cell using a second frequency range different from the first frequency range based at least in part on the beam prediction procedure.

Aspect 2: The method of aspect 1, wherein transmitting the one or more uplink messages comprises: transmitting, using the uplink beam of the UE, the one or more uplink messages via the second serving cell using the second frequency range, wherein the second frequency range is higher in frequency than the first frequency range.

Aspect 3: The method of any of aspects 1 through 2, further comprising: transmitting the plurality of SRSs via the first serving cell via a first set of frequency resources of the first frequency range; and transmitting the one or more uplink messages via the second serving cell using a second set of frequency resources of the second frequency range.

Aspect 4: The method of any of aspects 1 through 3, wherein receiving the control signal comprises: receiving, via the first serving cell using the first frequency range or via the second serving cell using the second frequency range, a DCI message or a MAC-CE message that comprises the directional information for the UE.

Aspect 5: The method of aspect 4, wherein receiving the DCI message via the first serving cell comprises: receiving the DCI message comprising an uplink grant that schedules transmission of an uplink message via the second serving cell, wherein the one or more uplink messages includes the uplink message.

Aspect 6: The method of any of aspects 4 through 5, wherein receiving the DCI message via the second serving cell comprises: receiving the DCI message comprising a downlink grant indicating a TCI state change, the TCI state change indicating the directional information.

Aspect 7: The method of any of aspects 4 through 6, wherein receiving the DCI message via the second serving cell comprises: receiving, via the second serving cell, the DCI message comprising an uplink grant scheduling a transmission of an uplink message via the second serving cell, the one or more uplink messages including the uplink message, the DCI message comprising an SRI indicating the directional information or a TPMI indicating the directional information.

Aspect 8: The method of any of aspects 4 through 7, further comprising: receiving, before reception of the control signal, a RRC message indicating that the directional information is based at least in part on the plurality of SRSs transmitted via the first serving cell.

Aspect 9: The method of any of aspects 4 through 8, wherein receiving the MAC-CE message via the first serving cell or via the second serving cell comprises: receiving the MAC-CE message comprising the directional information, wherein the MAC-CE message indicates a serving cell identifier associated with the first serving cell.

Aspect 10: The method of any of aspects 1 through 9, wherein receiving the control signal comprises: receiving the control signal comprising the directional information based at least in part on estimated uplink AoA information, the estimated uplink AoA information based at least in part on the plurality of SRSs transmitted via the first serving cell.

Aspect 11: The method of any of aspects 1 through 10, wherein receiving the control signal comprises: receiving the control signal comprising the directional information that indicates one or more SRS resources used for transmission of the plurality of SRSs or one or more SRS ports used for transmission of the plurality of SRSs.

Aspect 12: The method of any of aspects 1 through 11, wherein receiving the control signal comprises: receiving, via the second serving cell, the control signal comprising an uplink TCI state configuration, the uplink TCI state configuration comprising the directional information that is based at least in part on the plurality of SRSs transmitted via the first serving cell.

Aspect 13: The method of any of aspects 1 through 12, further comprising: transmitting, using the plurality of beams of the UE, the plurality of SRSs via the first serving cell and via a third serving cell that supports communications for the UE using a third frequency range different from both the first frequency range and the second frequency range.

Aspect 14: A method for wireless communications at a first network entity, comprising: receiving, from a UE, a plurality of SRSs via a first serving cell that supports communications with the UE using a first frequency range; and transmitting a control signal comprising directional information to the UE via the first serving cell, the directional information based at least in part on channel propagation characteristics between the UE and the first network entity wherein the channel propagation characteristics are based at least in part on the plurality of SRSs received via the first serving cell.

Aspect 15: The method of aspect 14, further comprising: receiving the plurality of SRSs via the first serving cell via a set of frequency resources of the first frequency range.

Aspect 16: The method of any of aspects 14 through 15, wherein transmitting the control signal comprises: transmitting, via the first serving cell using the first frequency range, a DCI message or a MAC-CE message that comprises the directional information for the UE.

Aspect 17: The method of aspect 16, wherein transmitting the DCI message via the first serving cell comprises: transmitting the DCI message comprising an uplink grant that schedules transmission of an uplink message via a second serving cell using a second frequency range.

Aspect 18: The method of any of aspects 14 through 17, wherein transmitting the control signal comprises: transmitting the control signal comprising the directional information that indicates one or more SRS resources used for receiving of the plurality of SRSs or one or more SRS ports used for reception of the plurality of SRSs.

Aspect 19: The method of any of aspects 14 through 18, further comprising: receiving, the plurality of SRSs via the first serving cell and via a third serving cell that supports communication for the UE using a third frequency range different from the first frequency range.

Aspect 20: A method for wireless communications at a first network entity, comprising: receiving, from a second network entity, a message indicating channel propagation characteristics between a UE and the second network entity, the second network entity operating via a first serving cell using a first frequency range; transmitting a control signal comprising directional information to the UE via a second serving cell using a second frequency range different from the first frequency range, the directional information identified based at least in part on the message from the second network entity including the channel propagation characteristics between the UE and the second network entity via the first serving cell; and receiving, one or more uplink messages, from an uplink beam of the UE, the one or more uplink messages received via the second serving cell using the second frequency range in accordance with the directional information.

Aspect 21: The method of aspect 20, wherein receiving the one or more uplink messages comprises: receiving, from the uplink beam of the UE, the one or more uplink messages via the second serving cell using the second frequency range, wherein the second frequency range is higher in frequency than the first frequency range.

Aspect 22: The method of any of aspects 20 through 21, further comprising: receiving the one or more uplink messages via the second serving cell using a set of frequency resources of the second frequency range.

Aspect 23: The method of any of aspects 20 through 22, wherein transmitting the control signal comprises: transmitting, via the second serving cell using the second frequency range, a DCI message or a MAC-CE that comprises the directional information for the UE.

Aspect 24: The method of aspect 23, wherein transmitting the DCI message via the second serving cell comprises: transmitting the DCI message comprising a downlink grant indicating a TCI state change indicating the directional information.

Aspect 25: The method of any of aspects 23 through 24, wherein transmitting the DCI message via the second serving cell comprises: transmitting, via the second serving cell, the DCI message comprising an uplink grant scheduling a transmission of an uplink message via the second serving cell, the one or more uplink messages including the uplink message, the DCI message comprising an SRI indicating the directional information or a TPMI indicating the directional information.

Aspect 26: The method of any of aspects 20 through 25, wherein transmitting the control signal comprises: transmitting, via the second serving cell, the control signal comprising an uplink TCI state configuration, the uplink TCI state configuration comprising the directional information.

Aspect 27: An apparatus for wireless communications at UE, comprising a processor; memory coupled with the processor; and instructions stored in the memory and executable by the processor to cause the apparatus to perform a method of any of aspects 1 through 13.

Aspect 28: An apparatus for wireless communications at UE, comprising at least one means for performing a method of any of aspects 1 through 13.

Aspect 29: A non-transitory computer-readable medium storing code for wireless communications at UE, the code comprising instructions executable by a processor to perform a method of any of aspects 1 through 13.

Aspect 30: An apparatus for wireless communications at a first network entity, comprising a processor; memory coupled with the processor; and instructions stored in the memory and executable by the processor to cause the apparatus to perform a method of any of aspects 14 through 19.

Aspect 31: An apparatus for wireless communications at a first network entity, comprising at least one means for performing a method of any of aspects 14 through 19.

Aspect 32: A non-transitory computer-readable medium storing code for wireless communications at a first network entity, the code comprising instructions executable by a processor to perform a method of any of aspects 14 through 19.

Aspect 33: An apparatus for wireless communications at a first network entity, comprising a processor; memory coupled with the processor; and instructions stored in the memory and executable by the processor to cause the apparatus to perform a method of any of aspects 20 through 26.

Aspect 34: An apparatus for wireless communications at a first network entity, comprising at least one means for performing a method of any of aspects 20 through 26.

Aspect 35: A non-transitory computer-readable medium storing code for wireless communications at a first network entity, the code comprising instructions executable by a processor to perform a method of any of aspects 20 through 26.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communications at user equipment (UE), comprising:
a processor;
memory coupled with the processor; and
instructions stored in the memory and executable by the processor to cause the apparatus to:
transmit, using a plurality of beams of the UE, a plurality of sounding reference signals via a first serving cell that supports communications for the UE using a first frequency range;
receive a control signal comprising directional information for the UE the directional information based at least in part on channel propagation characteristics between the UE and a network entity, wherein the channel propagation characteristics are based at least in part on the plurality of sounding reference signals transmitted via the first serving cell;
perform, based at least in part on the directional information, a beam prediction procedure to predict an uplink beam of the UE for communicating via a second serving cell different from the first serving cell; and
transmit, using the uplink beam of the UE, one or more uplink messages via the second serving cell using a second frequency range different from the first frequency range based at least in part on the beam prediction procedure.

2. The apparatus of claim 1, wherein the instructions to transmit the one or more uplink messages are executable by the processor to cause the apparatus to:
transmit, using the uplink beam of the UE, the one or more uplink messages via the second serving cell using the second frequency range, wherein the second frequency range is higher in frequency than the first frequency range.

3. The apparatus of claim 1, wherein the instructions are further executable by the processor to cause the apparatus to:
transmit the plurality of sounding reference signals via the first serving cell via a first set of frequency resources of the first frequency range; and
transmit the one or more uplink messages via the second serving cell using a second set of frequency resources of the second frequency range.

4. The apparatus of claim 1, wherein the instructions to receive the control signal are executable by the processor to cause the apparatus to:
receive, via the first serving cell using the first frequency range or via the second serving cell using the second frequency range, a downlink control information message or a medium access control channel element message that comprises the directional information for the UE.

5. The apparatus of claim 4, wherein the instructions to receive the downlink control information message via the first serving cell are executable by the processor to cause the apparatus to:
receive the downlink control information message comprising an uplink grant that schedules transmission of an uplink message via the second serving cell, wherein the one or more uplink messages includes the uplink message.

6. The apparatus of claim 4, wherein the instructions to receive the downlink control information message via the second serving cell are executable by the processor to cause the apparatus to:
receive the downlink control information message comprising a downlink grant indicating a transmission configuration indication state change, the transmission configuration indication state change indicating the directional information.

7. The apparatus of claim 4, wherein the instructions to receive the downlink control information message via the second serving cell are executable by the processor to cause the apparatus to:
receive, via the second serving cell, the downlink control information message comprising an uplink grant scheduling a transmission of an uplink message via the second serving cell, the one or more uplink messages including the uplink message, the downlink control information message comprising a sounding reference signal resource indicator indicating the directional information or a transmit precoder matrix indicator indicating the directional information.

8. The apparatus of claim 4, wherein the instructions are further executable by the processor to cause the apparatus to:
receive, before reception of the control signal, a radio resource control message indicating that the directional information is based at least in part on the plurality of sounding reference signals transmitted via the first serving cell.

9. The apparatus of claim 4, wherein the instructions to receive the medium access control channel element message via the first serving cell or via the second serving cell are executable by the processor to cause the apparatus to:
receive the medium access control channel element message comprising the directional information, wherein the medium access control channel element message indicates a serving cell identifier associated with the first serving cell.

10. The apparatus of claim 1, wherein the instructions to receive the control signal are executable by the processor to cause the apparatus to:
receive the control signal comprising the directional information based at least in part on estimated uplink angle of arrival information, the estimated uplink angle of arrival information based at least in part on the plurality of sounding reference signals transmitted via the first serving cell.

11. The apparatus of claim 1, wherein the instructions to receive the control signal are executable by the processor to cause the apparatus to:
receive the control signal comprising the directional information that indicates one or more sounding reference signal resources used for transmission of the plurality of sounding reference signals or one or more sounding reference signal ports used for transmission of the plurality of sounding reference signals.

12. The apparatus of claim 1, wherein the instructions to receive the control signal are executable by the processor to cause the apparatus to:
receive, via the second serving cell, the control signal comprising an uplink transmission configuration indication state configuration, the uplink transmission configuration indication state configuration comprising the directional information that is based at least in part on the plurality of sounding reference signals transmitted via the first serving cell.

13. The apparatus of claim 1, wherein the instructions are further executable by the processor to cause the apparatus to:
transmit, using the plurality of beams of the UE, the plurality of sounding reference signals via the first serving cell and via a third serving cell that supports communications for the UE using a third frequency range different from both the first frequency range and the second frequency range.

14. An apparatus for wireless communications at a first network entity, comprising:
a processor;
memory coupled with the processor; and
instructions stored in the memory and executable by the processor to cause the apparatus to:
receive, from a user equipment (UE), a plurality of sounding reference signals via a first serving cell that supports communications with the UE using a first frequency range; and
transmit a control signal comprising directional information to the UE via the first serving cell, the directional information based at least in part on channel propagation characteristics between the UE and the first network entity wherein the channel propagation characteristics are based at least in part on the plurality of sounding reference signals received via the first serving cell.

15. The apparatus of claim 14, wherein the instructions are further executable by the processor to cause the apparatus to:
receive the plurality of sounding reference signals via the first serving cell via a set of frequency resources of the first frequency range.

16. The apparatus of claim 14, wherein the instructions to transmit the control signal are executable by the processor to cause the apparatus to:
transmit, via the first serving cell using the first frequency range, a downlink control information message or a medium access control control element message that comprises the directional information for the UE.

17. The apparatus of claim 16, wherein the instructions to transmit the downlink control information message via the first serving cell are executable by the processor to cause the apparatus to:
transmit the downlink control information message comprising an uplink grant that schedules transmission of an uplink message via a second serving cell using a second frequency range.

18. The apparatus of claim 14, wherein the instructions to transmit the control signal are executable by the processor to cause the apparatus to:
transmit the control signal comprising the directional information that indicates one or more sounding reference signal resources used for receiving of the plurality of sounding reference signals or one or more sounding reference signal ports used for reception of the plurality of sounding reference signals.

19. The apparatus of claim 14, wherein the instructions are further executable by the processor to cause the apparatus to:
receive, the plurality of sounding reference signals via the first serving cell and via a third serving cell that supports communication for the UE using a third frequency range different from the first frequency range.

20-26. (canceled)

27. A method for wireless communications at user equipment (UE), comprising:
transmitting, using a plurality of beams of the UE, a plurality of sounding reference signals via a first serving cell that supports communications for the UE using a first frequency range;
receiving a control signal comprising directional information for the UE the directional information based at least in part on channel propagation characteristics between the UE and a network entity, wherein the channel propagation characteristics are based at least in part on the plurality of sounding reference signals transmitted via the first serving cell;
performing, based at least in part on the directional information, a beam prediction procedure to predict an uplink beam of the UE for communicating via a second serving cell different from the first serving cell; and
transmitting, using the uplink beam of the UE, one or more uplink messages via the second serving cell using a second frequency range different from the first frequency range based at least in part on the beam prediction procedure.

28-30. (canceled)
